(19) United States
(12) Patent Application Publication
(10) Pub. No.: US 2016/0147942 A1
(43) Pub. Date: May 26, 2016

(54) SYSTEM, METHOD AND COMPUTER READABLE MEDIUM FOR EXECUTING SOFTWARE IN COMPLIANCE WITH HEALTH DATA STANDARDS, QUALITY CONTROL PROTOCOLS, AND DEVICE OPERATING SYSTEMS

(71) Applicant: FIO CORPORATION, Toronto (CA)

(72) Inventor: Michael CHMURA, Mississauga (CA)

(21) Appl. No.: 14/442,295

(22) PCT Filed: Nov. 12, 2013
(86) PCT No.: PCT/CA2013/000953

§ 371 Date: May 12, 2015

Related U.S. Application Data
(60) Provisional application No. 61/725,460, filed on Nov. 12, 2012.
(60) Provisional application No. 61/816,010, filed on Apr. 25, 2013.

(51) Int. Cl. G06F 19/00; G06F 9/54; G06F 21/62; G06F 17/30

(52) U.S. Cl. CPC G06F 19/322; G06F 17/3056; G06F 9/54; G06F 19/321; G06F 21/6218

(57) ABSTRACT

A launcher system, method and computer readable medium are used with software and a device having an operating system. They provide an API sub-layer which communicates with the software, and an interfacing sub-layer which communicates with the device. A logic sub-layer automatically receives health standards and protocols governing use of health data, operation and quality control of the device, the operating system, and the software application in health-related fields. The logic sub-layer mediates communication between the API sub-layer and the interfacing sub-layer, and ensures the use of health data, the operation and the quality control of the software application, the operating system and the electronic device are in compliance with all of the applicable health standards and protocols.

### FIELD OF THE INVENTION

The present disclosure relates generally to a system, method and computer readable medium for executing software, and more particularly to a system, method and computer readable medium for executing software in compliance with health data standards, quality control protocols, and device operating systems.

### BACKGROUND OF THE INVENTION

Devices with operating systems, including a large spectrum of computing devices (and including, among others, devices which may be stationary, mobile and/or embedded) are increasingly being used by health professionals, patients and others around the world to provide patient services at, near or remote from the point of care. Even the simplest of these software driven devices today may contain a form of modern operating system, for example, to manage hardware resources, schedule computation and/or present output to users.

To this end, numerous software applications have been coded for execution within the context of a variety of different device operating systems—e.g., the iOS or OS X operating system offered by Apple Inc. (of Cupertino, Calif.), the Android operating system offered by Google Inc. (of Mountain View, Calif.), the GNU/Linux operating system promoted by the Free Software Foundation (of Boston, Mass.), or the Windows operating system offered by Microsoft Corporation (of Redmond, Wash.).

Previously, such software applications may not have been executed in compliance with, for example, health data standards and/or quality control protocols. In the result, the applications may have been capable of use in violation of health, data, privacy, security, quality control, and/or other applicable protocols, standards, rules and/or regulations in the various jurisdictions where such devices may have been located.

In addition, prior art software applications coded for use in conjunction with a particular device operating system may not have been readily usable on devices with a different underlying operating system.

The aforementioned disadvantages and/or shortcomings associated with the prior art may have been made somewhat more problematic and/or troublesome by some of the other functionalities which typically may be provided by devices—e.g., location services and/or camera functionalities on mobile devices. In some situations, it may be preferred, desired and/or required to continue to provide such functionalities in association with health care applications and, in other situations, to completely disable them. Prior art software applications may not have been coded, or provided with access, for controlling these other functionalities provided by devices.

In the prior art, it may also have been disadvantageous and/or a shortcoming of previous software applications to comply with certain health data and/or privacy standards, as they may not have coded for anonymizing at least a portion, and in some cases, all identifying patient data.

What may be needed is a system, method and/or computer readable medium which overcomes, traverses, obviates and/or mitigates one or more of the limitations associated with the prior art, and/or helps to do so.

It may be an object of one aspect of the present invention to provide a system, method and/or computer readable medium which provides for executing applications in compliance with health, data, privacy, security, quality control, and/or other applicable protocols, standards, rules and/or regulations in the various jurisdictions local to the devices executing them.

It may be an object of one aspect of the present invention to provide an overarching system, method and/or computer readable medium adapted to readily enable applications coded for use in conjunction with a particular device operating system to be used on devices with a different underlying operating system.

It may be an object of one aspect of the present invention to provide a system, method and/or computer readable medium which manages (i.e., provides and/or disables as appropriate) health care applications' access to device functionalities such as, for example, location services and/or camera functionalities.

It may be an object of one aspect of the present invention to provide a system, method and/or computer readable medium which, when appropriate, anonymizes at least a portion, and in some cases, all identifying patient data.

It may be an object of one aspect of the present invention to provide a system, method and/or computer readable medium for executing software applications in compliance with health data standards, quality control protocols, and/or an underlying device operating system.

It may be an object of one aspect of the present invention to provide a system, method and/or computer readable medium which enables a large spectrum of computing devices to become connected to and/or compliant with central data stores and/or databases using standard communication protocols, typically, for example such as the HL7, POCT1, and/or DICOM standards (each of which is described in greater detail elsewhere herein).

It may be an object of one aspect of the present invention to provide an overarching system, method and/or computer readable medium which is adapted to execute software applications.

It may be an object of one aspect of the present invention to provide an overarching system, method and/or computer readable medium adapted to execute software applications in compliance with health data standards.

It may be an object of one aspect of the present invention to provide an overarching system, method and/or computer readable medium adapted to execute software applications in compliance with quality control protocols.

It may be an object of one aspect of the present invention to provide an overarching system, method and/or computer readable medium adapted to execute software applications in compliance with underlying device operating systems.

It is an object of the present invention to obviate or mitigate one or more of the aforementioned disadvantages and/or shortcomings associated with the prior art, to provide one of the aforementioned needs or advantages, and/or to achieve one or more of the aforementioned objectives of the invention.

Prior attempts, if any, to solve problems associated with prior art diagnostic devices, systems, methods and/or computer readable media may have been unsuccessful and/or had one or more disadvantages associated with them. Prior art diagnostic devices, systems, methods and/or computer readable media may have been ill-suited to solve the stated problems and/or the shortcomings which have been associated with them.

It is an object of the present invention to obviate or mitigate one or more of the aforementioned disadvantages and/or shortcomings associated with the prior art, to provide one of the aforementioned needs or advantages, and/or to achieve one or more of the aforementioned objects of the invention.

### SUMMARY OF THE INVENTION

According to the invention, there is disclosed a launcher system for use, in health-related fields, by a user of an executable software application and an electronic device having an operating system. The launcher system is also for use with one or more databases which store one or more applicable health standards and/or protocols governing proper use of health data, operation and/or quality control of the electronic device, the operating system, and/or the software application in the health-related fields. The launcher system includes an application programming interface (API) sub-layer which communicates with the software application. The launcher system also includes an interfacing sub-layer which communicates with the operating system and/or the electronic device. The launcher system also includes a logic sub-layer which automatically: (i) receives the health standards and/or protocols from the databases; (ii) mediates communication between the API sub-layer and the interfacing sub-layer; and (iii) ensures the use of health data, the operation and/or the quality control of the software application, the operating system and/or the electronic device are in compliance with all of the applicable health standards and/or protocols.

According to the invention, there is also disclosed a launcher system for use, in health-related fields, by a user of an executable software application and an electronic device having an operating system. The launcher system includes one or more databases which include one or more applicable health standards and/or protocols. The health standards and/or protocols govern proper use of health data, operation and/or quality control of the electronic device, the operating system, and/or the software application in the health-related fields. The launcher system also includes an application programming interface (API) sub-layer which communicates with the software application. The launcher system also includes an interfacing sub-layer which communicates with the operating system and/or the electronic device. The launcher system also includes a logic sub-layer which automatically: (i) receives the health standards and/or protocols from the databases; (ii) mediates communication between the API sub-layer and the interfacing sub-layer; and (iii) ensures the use of health data, the operation and/or the quality control of the software application, the operating system and/or the electronic device are in compliance with all of the applicable health standards and/or protocols.

According to an aspect of one preferred embodiment of the invention, the launcher system may preferably, but need not necessarily, also include a graphical user interface (GUI) which may preferably, but need not necessarily, be presented to the user, preferably following startup of the electronic device. The GUI may preferably, but need not necessarily, mediate interactions of the user with the software application, the operating system and/or the electronic device.

According to an aspect of one preferred embodiment of the invention, the health standards and/or protocols may preferably, but need not necessarily, include privacy and/or security standards and/or protocols which may preferably, but need not necessarily, govern proper privacy and/or security of health data, the software application, the operating system, and/or the electronic device in the health-related fields.

According to an aspect of one preferred embodiment of the invention, one or more of the health standards and/or protocols may preferably, but need not necessarily, be selected from the group consisting of: the United States' Health Insurance Portability and Accountability Act (HIPAA) standard; the Health Level Seven (HL7) framework and/or standards; the Hypertext Transfer Protocol Secure (HTTPS) communications protocol; the Point-of-Care Connectivity (POCT1) standard; and/or the Digital Imaging and Communications in Medicine (DICOM) standard.

According to an aspect of one preferred embodiment of the invention, the health standards and/or protocols may preferably, but need not necessarily, include in vitro diagnostic protocols which may preferably, but need not necessarily, govern proper in vitro diagnostic methodologies for the software application, the operating system, and/or the electronic device.

According to an aspect of one preferred embodiment of the invention, the health standards and/or protocols may preferably, but need not necessarily, be jurisdictionally specific.

According to an aspect of one preferred embodiment of the invention, the logic sub-layer may preferably, but need not necessarily, automatically receive the health standards and/or protocols depending on a jurisdiction, preferably the jurisdiction in which the electronic device is located.

According to an aspect of one preferred embodiment of the invention, the databases may preferably, but need not necessarily, be located remotely from the electronic device.

According to an aspect of one preferred embodiment of the invention, the databases may preferably, but need not necessarily, store patient results which preferably include patient identifying information. The logic sub-layer may preferably, but need not necessarily, restrict access to the patient results, preferably restricting such access other than by the user who collected the patient results.

According to an aspect of one preferred embodiment of the invention, the logic sub-layer may preferably, but need not necessarily, anonymize any patient results which are output from the software application, preferably to remove any patient identifying information.

According to an aspect of one preferred embodiment of the invention, the databases may preferably, but need not necessarily, anonymously store one or more aggregate results, preferably absent any patient identifying information. The logic sub-layer may preferably, but need not necessarily, permit the software applications to store and/or access the aggregate results.

According to an aspect of one preferred embodiment of the invention, the databases may preferably, but need not necessarily, store the software application. The launcher system may preferably, but need not necessarily, retrieve the software application from the databases, preferably for execution by the electronic device.

According to an aspect of one preferred embodiment of the invention, the databases may preferably, but need not necessarily, store one or more launcher operating system versions. Each launcher operating system version may preferably, but need not necessarily, be adapted to encode the interfacing sub-layer, preferably to function with at least one aforesaid operating system, and/or preferably agnostic of any intended execution of the software application in association with any aforesaid operating system. The interfacing sub-layer may preferably, but need not necessarily, automatically receive—preferably depending on the operating system of the electronic device—one of the launcher operating system versions, preferably to automatically encode the interfacing sub-layer, and/or preferably to function with the operating system of the electronic device.

According to an aspect of one preferred embodiment of the invention, the databases may preferably, but need not necessarily, store one or more launcher operating system versions. Each launcher operating system version may preferably, but need not necessarily, be adapted to encode the API sub-layer to execute the software application, preferably in view of an intended execution of the software application with one aforesaid operating system, and/or preferably agnostic of the operating system of the electronic device. The API sub-layer may preferably, but need not necessarily, automatically receive—preferably depending on the intended execution of the software application with one aforesaid operating system—one of the launcher operating system versions, preferably to automatically encode the API sub-layer, and/or preferably to execute the software application.

According to an aspect of one preferred embodiment of the invention, the databases may preferably, but need not necessarily, store one or more launcher operating system versions. Each launcher operating system version may preferably, but need not necessarily, be adapted to encode the interfacing sub-layer, preferably to function with a first one aforesaid operating system and/or preferably to encode the API sub-layer, preferably to execute the software application, preferably in view of an intended execution of the software application with a second one aforesaid operating system, preferably different than the first one. The interfacing sub-layer and/or the API sub-layer may preferably, but need not necessarily, automatically receive—preferably depending on the first one and/or the second one aforesaid operating system—one of the launcher operating system versions, preferably to automatically encode the interfacing sub-layer, preferably to function with the operating system of the electronic device, and/or preferably to automatically encode the API sub-layer, preferably to execute the software application.

According to an aspect of one preferred embodiment of the invention, the interfacing sub-layer may preferably, but need not necessarily, communicate directly with the electronic device, preferably free of the operating system, and/or preferably when appropriate in view of the health standards and/or protocols.

According to an aspect of one preferred embodiment of the invention, the API sub-layer and/or the interfacing sub-layer may preferably, but need not necessarily, communicate directly with each other, preferably free of mediation by the logic sub-layer, and/or preferably when appropriate in view of the health standards and/or protocols.

According to an aspect of one preferred embodiment of the invention, the interfacing sub-layer may preferably, but need not necessarily, disable access of the software application to any location services and/or camera functionalities otherwise afforded by the electronic device.

According to an aspect of one preferred embodiment of the invention, preferably in mediating communication between the API sub-layer and/or the interfacing sub-layer and/or preferably in ensuring compliance with all of the applicable health standards and/or protocols, the logic sub-layer may preferably, but need not necessarily, automatically restrict and/or modify one or more functions of, and/or communication between, the software application, the operating system and/or the electronic device.

According to an aspect of one preferred embodiment of the invention, the launcher system may preferably, but need not necessarily, be adapted for use with a mobile device or a stationary device, preferably as the electronic device.

According to the invention, there is also disclosed a method for use, in health-related fields, by a user of an executable software application and an electronic device having an operating system. The method includes step (a) of using one or more databases for storage of one or more applicable health standards and/or protocols. The health standards and/or protocols govern proper use of health data, operation and/or quality control of the electronic device, the operating system, and/or the software application in the health-related fields. The method also includes step (b) of using an application programming interface (API) sub-layer to communicate with the software application. The method also includes step (c) of using an interfacing sub-layer to communicate with the operating system and/or the electronic device. The method also includes step (d) of using a logic sub-layer to automatically: (i) receive the health standards and/or protocols from the databases; (ii) mediate communication between the API sub-layer and the interfacing sub-layer; and (iii) ensure the use of health data, the operation and/or the quality control of the software application, the operating system and/or the electronic device are in compliance with all of the applicable health standards and/or protocols.

According to an aspect of one preferred embodiment of the invention, the method may preferably, but need not necessarily, also include the step of presenting a graphical user interface to the user, preferably following startup of the electronic device. The graphical user interface may preferably, but need not necessarily, be used to mediate interactions of the user with the software application, the operating system and/or the electronic device.

According to an aspect of one preferred embodiment of the invention, preferably in steps (a) and/or (d), the health standards and/or protocols may preferably, but need not necessarily, include privacy and/or security standards and/or protocols which may preferably, but need not necessarily, govern proper privacy and/or security of health data, the software application, the operating system, and/or the electronic device in the health-related fields.

According to an aspect of one preferred embodiment of the invention, preferably in steps (a) and/or (d), one or more of the health standards and/or protocols may preferably, but need not necessarily, be selected from the group consisting of: the United States' Health Insurance Portability and Accountability Act (HIPAA) standard; the Health Level Seven (HL7) framework and/or standards; the Hypertext Transfer Protocol Secure (HTTPS) communications protocol; the Point-of-Care Connectivity (POCT1) standard; and/or the Digital Imaging and Communications in Medicine (DICOM) standard.

According to an aspect of one preferred embodiment of the invention, preferably in steps (a) and/or (d), the health standards and/or protocols may preferably, but need not necessarily, include in vitro diagnostic protocols which may preferably, but need not necessarily, govern proper in vitro diagnostic methodologies for the software application, the operating system, and/or the electronic device.

According to an aspect of one preferred embodiment of the invention, preferably in steps (a) and/or (d), the health standards and/or protocols may preferably, but need not necessarily, be jurisdictionally specific.

According to an aspect of one preferred embodiment of the invention, preferably in step (d), the logic sub-layer may preferably, but need not necessarily, automatically receive the health standards and/or protocols, preferably depending on a jurisdiction, preferably the jurisdiction in which the electronic device is located.

According to an aspect of one preferred embodiment of the invention, preferably in step (a), the databases may preferably, but need not necessarily, be located remotely from the electronic device.

According to an aspect of one preferred embodiment of the invention, preferably in step (a), the databases may preferably, but need not necessarily, also be used to store patient results, preferably including patient identifying information. Preferably in step (d), the logic sub-layer may preferably, but need not necessarily, restrict access to the patient results, preferably other than by the user who collected the patient results.

According to an aspect of one preferred embodiment of the invention, preferably in step (d), the logic sub-layer may preferably, but need not necessarily, anonymize any patient results which are output from the software application, preferably to remove any patient identifying information.

According to an aspect of one preferred embodiment of the invention, preferably in step (a), the databases may preferably, but need not necessarily, also be used to anonymously store one or more aggregate results, preferably absent any patient identifying information. Preferably in step (d), the logic sub-layer may preferably, but need not necessarily, permit the software applications to store and/or access the aggregate results.

According to an aspect of one preferred embodiment of the invention, preferably in step (a), the databases may preferably, but need not necessarily, also be used to store the software application. The method may preferably, but need not necessarily, also include the step of retrieving the software application, preferably from the databases and/or preferably for execution.

According to an aspect of one preferred embodiment of the invention, preferably in step (a), the databases may preferably, but need not necessarily, also be used to store one or more launcher operating system versions. Each launcher operating system version may preferably, but need not necessarily, be adapted to encode the interfacing sub-layer, preferably to function with at least one aforesaid operating system, and/or preferably agnostic of any intended execution of the software application in association with any aforesaid operating system. The method may preferably, but need not necessarily, also include the step, preferably before step (c), wherein the interfacing sub-layer may preferably, but need not necessarily, automatically receive—preferably depending on the operating system of the electronic device—one of the launcher operating system versions, preferably to automatically encode the interfacing sub-layer, and/or preferably to function with the operating system of the electronic device.

According to an aspect of one preferred embodiment of the invention, preferably in step (a), the databases may preferably, but need not necessarily, also be used to store one or more launcher operating system versions. Each launcher operating system version may preferably, but need not necessarily, be adapted to encode the API sub-layer, preferably to execute the software application in view of an intended execution of the software application with one aforesaid operating system, and/or preferably agnostic of the operating system of the electronic device. The method may preferably, but need not necessarily, also include the step, preferably before step (b), wherein the API sub-layer automatically receives—preferably depending on the intended execution of the software application with one aforesaid operating system—one of the launcher operating system versions, preferably to automatically encode the API sub-layer, and/or preferably to execute the software application.

According to an aspect of one preferred embodiment of the invention, preferably in step (a), the databases may preferably, but need not necessarily, also be used to store one or more launcher operating system versions. Each launcher operating system version may preferably, but need not necessarily, be adapted to encode the interfacing sub-layer preferably to function with a first one aforesaid operating system and/or preferably to encode the API sub-layer to execute the software application preferably in view of an intended execution of the software application with a second one aforesaid operating system, preferably different than the first one. The method may preferably, but need not necessarily, also include the step, preferably before steps (b) and/or (c), wherein the interfacing sub-layer and/or the API sub-layer automatically receive—preferably depending on the first one and/or the second one aforesaid operating system—one of the launcher operating system versions preferably to automatically encode the interfacing sub-layer, preferably to function with the operating system of the electronic device, and/or preferably to automatically encode the API sub-layer, preferably to execute the software application.

According to an aspect of one preferred embodiment of the invention, preferably in step (c) and/or after step (d), the interfacing sub-layer may preferably, but need not necessarily, communicate directly with the electronic device, preferably free of the operating system, and/or preferably when appropriate in view of the health standards and/or protocols.

According to an aspect of one preferred embodiment of the invention, the method may preferably, but need not necessarily, also include the step, preferably after step (d), wherein the API sub-layer and/or the interfacing sub-layer may preferably, but need not necessarily, communicate directly with each other, preferably free of mediation by the logic sub-layer, and/or preferably when appropriate in view of the health standards and/or protocols.

According to an aspect of one preferred embodiment of the invention, preferably in step (d), the interfacing sub-layer may preferably, but need not necessarily, disable access of the software application to any location services and/or camera functionalities otherwise afforded by the electronic device.

According to an aspect of one preferred embodiment of the invention, preferably in steps (d)(ii) and/or (d)(iii), the logic sub-layer may preferably, but need not necessarily, automatically restrict and/or modify one or more functions of, and/or communication between, the software application, the operating system and/or the electronic device.

According to an aspect of one preferred embodiment of the invention, the method may preferably, but need not necessarily, be adapted for use with a mobile device or a stationary device, preferably as the electronic device.

According to the invention, there is also disclosed a computer readable medium for use, in health-related fields, by a user of an executable software application and an electronic device having an operating system. The computer readable medium is encoded with executable instructions to, when executed, encode one or more processors to automatically perform step (a) of using an application programming interface (API) sub-layer to communicate with the software application. The executable instructions, when executed, also encode the processors to automatically perform step (b) of using an interfacing sub-layer to communicate with the operating system and/or the electronic device. The executable instructions, when executed, also encode the processors to automatically perform step (c) of using a logic sub-layer to automatically: (i) receive one or more applicable health standards and/or protocols from one or more databases, wherein the health standards and/or protocols govern proper use of health data, operation and/or quality control of the electronic device, the operating system, and/or the software application in the health-related fields; (ii) mediate communication between the API sub-layer and the interfacing sub-layer; and (iii) ensure the use of health data, the operation and/or the quality control of the software application, the operating system and/or the electronic device are in compliance with all of the applicable health standards and/or protocols.

According to an aspect of one preferred embodiment of the invention, the executable instructions, preferably when executed, may preferably, but need not necessarily, further encode the processors preferably to: present a graphical user interface to the user, preferably following startup of the electronic device; and/or use the graphical user interface to mediate interactions of the user with the software application, the operating system and/or the electronic device.

According to an aspect of one preferred embodiment of the invention, the executable instructions, preferably when executed, may preferably, but need not necessarily, encode the processors such that, preferably in step (c), the health standards and/or protocols may preferably, but need not necessarily, include privacy and/or security standards and/or protocols which may preferably, but need not necessarily, govern proper privacy and/or security of health data, the software application, the operating system, and/or the electronic device in the health-related fields.

According to an aspect of one preferred embodiment of the invention, the executable instructions, preferably when executed, may preferably, but need not necessarily, encode the processors such that, preferably in step (c), one or more of the health standards and/or protocols may preferably, but need not necessarily, be selected from the group consisting of: the United States' Health Insurance Portability and Accountability Act (HIPAA) standard; the Health Level Seven (HL7) framework and/or standards; the Hypertext Transfer Protocol Secure (HTTPS) communications protocol; the Point-of-Care Connectivity (POCT1) standard; and/or the Digital Imaging and Communications in Medicine (DICOM) standard.

According to an aspect of one preferred embodiment of the invention, the executable instructions, preferably when executed, may preferably, but need not necessarily, encode the processors such that, preferably in step (c), the health standards and/or protocols may preferably, but need not necessarily, include in vitro diagnostic protocols which may preferably, but need not necessarily, govern proper in vitro diagnostic methodologies for the software application, the operating system, and/or the electronic device.

According to an aspect of one preferred embodiment of the invention, the executable instructions, preferably when executed, may preferably, but need not necessarily, encode the processors such that, preferably in step (c), the health standards and/or protocols may preferably, but need not necessarily, be jurisdictionally specific.

According to an aspect of one preferred embodiment of the invention, the executable instructions, preferably when executed, may preferably, but need not necessarily, encode the processors such that, preferably in step (c), the logic sub-layer automatically may preferably, but need not necessarily, receives the health standards and/or protocols depending on a jurisdiction, preferably the jurisdiction in which the electronic device is located.

According to an aspect of one preferred embodiment of the invention, preferably in step (c), the databases may preferably, but need not necessarily, be located remotely from the electronic device.

According to an aspect of one preferred embodiment of the invention, the computer readable medium may preferably, but need not necessarily, be adapted for use with patient results which preferably include patient identifying information. The executable instructions, preferably when executed, may preferably, but need not necessarily, further encode the processors such that, preferably in step (c), the logic sub-layer may preferably, but need not necessarily, restrict access to the patient results, preferably other than by the user who collected the patient results.

According to an aspect of one preferred embodiment of the invention, the executable instructions, preferably when executed, may preferably, but need not necessarily, further encode the processors such that, preferably in step (c), the logic sub-layer may preferably, but need not necessarily, anonymize any patient results which are output from the software application, preferably to remove any patient identifying information.

According to an aspect of one preferred embodiment of the invention, the computer readable medium may preferably, but need not necessarily, be adapted for use with one or more aggregate results which may preferably, but need not necessarily, be anonymously stored in the databases, preferably absent any patient identifying information. The executable instructions, preferably when executed, may preferably, but need not necessarily, further encode the processors such that, preferably in step (c), the logic sub-layer may preferably, but need not necessarily, permit the software applications to store and/or access the aggregate results.

According to an aspect of one preferred embodiment of the invention, the computer readable medium may preferably, but need not necessarily, be adapted for use with the software application stored in the databases. The executable instructions, preferably when executed, may preferably, but need not necessarily, further encode the processors to retrieve the software application, preferably from the databases and/or for execution.

According to an aspect of one preferred embodiment of the invention, the executable instructions may preferably, but need not necessarily, also include one or more launcher operating system versions. Each launcher operating system version may preferably, but need not necessarily, be adapted to encode the interfacing sub-layer preferably to function with at least one aforesaid operating system, and/or preferably agnostic of any intended execution of the software application in association with any aforesaid operating system. The executable instructions, preferably when executed, may preferably, but need not necessarily, further encode the processors to perform the further step, preferably before step (b), wherein the interfacing sub-layer may preferably, but need not necessarily, automatically receive—preferably depending on the operating system of the electronic device—one of the launcher operating system versions preferably to automatically encode the interfacing sub-layer and/or preferably to function with the operating system of the electronic device.

According to an aspect of one preferred embodiment of the invention, the executable instructions may preferably, but need not necessarily, also include one or more launcher operating system versions. Each launcher operating system version may preferably, but need not necessarily, be adapted to encode the API sub-layer preferably to execute the software application, and/or preferably in view of an intended execution of the software application with one aforesaid operating system, and/or preferably agnostic of the operating system of the electronic device. The executable instructions, preferably when executed, may preferably, but need not necessarily, further encode the processors to perform the further step, preferably before step (a), wherein the API sub-layer may preferably, but need not necessarily, automatically receive—preferably depending on the intended execution of the software application with one aforesaid operating system—one of the launcher operating system versions preferably to automatically encode the API sub-layer, and/or preferably to execute the software application.

According to an aspect of one preferred embodiment of the invention, the executable instructions may preferably, but need not necessarily, also include one or more launcher operating system versions. Each operating system launcher version may preferably, but need not necessarily, be adapted to encode the interfacing sub-layer preferably to function with a first one aforesaid operating system and/or preferably to encode the API sub-layer preferably to execute the software application, and/or preferably in view of an intended execution of the software application with a second one aforesaid operating system, preferably different than the first one. The executable instructions, preferably when executed, may preferably, but need not necessarily, further encode the processors preferably to perform the further step, preferably before steps (a) and/or (b), wherein the interfacing sub-layer and/or the API sub-layer may preferably, but need not necessarily, automatically receive—preferably depending on the first one and/or the second one aforesaid operating system—one of the launcher operating system versions preferably to automatically encode the interfacing sub-layer preferably to function with the operating system of the electronic device, and/or preferably to automatically encode the API sub-layer preferably to execute the software application.

According to an aspect of one preferred embodiment of the invention, the executable instructions, preferably when executed, may preferably, but need not necessarily, further encode the processors such that, preferably in step (b) and/or after step (c), the interfacing sub-layer may preferably, but need not necessarily, communicate directly with the electronic device, preferably free of the operating system, and/or preferably when appropriate in view of the health standards and/or protocols.

According to an aspect of one preferred embodiment of the invention, the executable instructions, preferably when executed, may preferably, but need not necessarily, further encode the processors to perform the further step, preferably after step (c), wherein the API sub-layer and/or the interfacing sub-layer may preferably, but need not necessarily, communicate directly with each other, preferably free of mediation by the logic sub-layer, and/or preferably when appropriate in view of the health standards and/or protocols.

According to an aspect of one preferred embodiment of the invention, the executable instructions, preferably when executed, may preferably, but need not necessarily, encode the processors such that, preferably in step (c), the interfacing sub-layer may preferably, but need not necessarily, disable access of the software application to any location services and/or camera functionalities otherwise afforded by the electronic device.

According to an aspect of one preferred embodiment of the invention, the executable instructions, preferably when executed, may preferably, but need not necessarily, encode the processors such that, preferably in steps (c)(ii) and/or (c)(iii), the logic sub-layer may preferably, but need not necessarily, automatically restrict and/or modify one or more functions of, and/or communication between, the software application, the operating system and/or the electronic device.

According to an aspect of one preferred embodiment of the invention, the computer readable medium may preferably, but need not necessarily, be adapted for use with a mobile device or a stationary device, preferably as the electronic device.

Other advantages, features and/or characteristics of the present invention, as well as methods of operation and/or functions of the related elements of the system, method and computer readable medium, and/or the combination of steps, parts and/or economies of manufacture, will become more apparent upon consideration of the following detailed description and the appended claims with reference to the accompanying drawings, the latter of which are briefly described hereinbelow.

### BRIEF DESCRIPTION OF THE DRAWINGS

The novel features which are believed to be characteristic of the system, method and computer readable medium according to the present invention, as to their structure, organization, use, and/or method of operation, together with further objectives and/or advantages thereof, will be better understood from the following drawings in which presently preferred embodiments of the invention will now be illustrated by way of example. It is expressly understood, however, that the drawings are for the purpose of illustration and description only, and are not intended as a definition of the limits of the invention. In the accompanying drawings:

FIG. 1 is a schematic diagram depicting a launcher system, including a GUI, according to one preferred embodiment of the invention, shown in use with a device;

FIG. 2 is a user icon interface presented by the GUI and the device of FIG. 1;

FIGS. 3A and 3B are a normal user interface and a service user interface, respectively, presented by the GUI and the device of FIG. 1;

FIGS. 4A and 4B are an administrative user login interface and an administrative user interface, respectively, presented by the GUI and the device of FIG. 1;

FIG. 5 is a Quick Launcher Menu interface presented by the GUI and the device of FIG. 1;

FIGS. 6A and 6B are first and second Launcher home screen interfaces, respectively, presented by the GUI and the device of FIG. 1;

FIG. 7 is a Launcher User Interface, with many applications installed, presented by the GUI and the device of FIG. 1;

FIG. 8 is a patient home screen interface presented by the GUI and the device of FIG. 1;

FIG. 9 is a patient manager screen interface, depicting patients with tests, presented by the GUI and the device of FIG. 1;

FIG. 10 is a Clinic Dx Quick Launcher Menu interface presented by the GUI and the device of FIG. 1;

FIGS. 11A to 11F are illustrations of facility addition and management interfaces presented by the GUI and the device of FIG. 1;

FIGS. 12A to 12J are illustrations of patient addition, form addition, form selection, dialog, form deletion, and first screen interfaces presented by the GUI and the device of FIG. 1;

FIGS. 13A to 13H are illustrations of functional check dialogs, home screen, status screen, and failure screen interfaces presented by the GUI and the device of FIG. 1;

FIGS. 14A to 14G are illustrations of patient information function and menu interfaces presented by the GUI and the device of FIG. 1; and

FIGS. 15A to 15S are illustrations of test function and menu interfaces presented by the GUI and the device of FIG. 1.

### DETAILED DESCRIPTION OF THE PREFERRED EMBODIMENTS

According to the invention, there may preferably be provided a system, method and computer readable medium which facilitates the better use of devices by health professionals, patients and others around the world in providing patient services at, near or remote from the point of care. The system, method and computer readable medium according to the invention may preferably be standard and/or operating system agnostic, in the sense that it may preferably be capable of use—and/or may enable or facilitate the ready use of third party applications—in association with a wide variety of different: (a) health, data, privacy, security, quality control, and/or jurisdictional protocols, standards, rules and/or regulations; and/or (b) device operating systems.

The systems, methods and computer readable media provided according to the invention may incorporate, integrate or be for use with devices and/or operating systems on devices that are mobile or substantially stationary. Indeed, as previously indicated, the present invention is operating system agnostic. Accordingly, devices such as mobile communications devices (e.g., cellphones) and cameras may be used. Alternately and/or in addition, the devices may include desktop or laptop computers. Other devices, including medical devices, also fall within the scope of the devices (and the associated operating systems) which are contemplated.

The system, method and/or computer readable medium according to the invention may preferably act to intermediate communication between applications, a device, and its operating system. The system, method and/or computer readable medium according to the invention may preferably act as a data broker and/or data verifier.

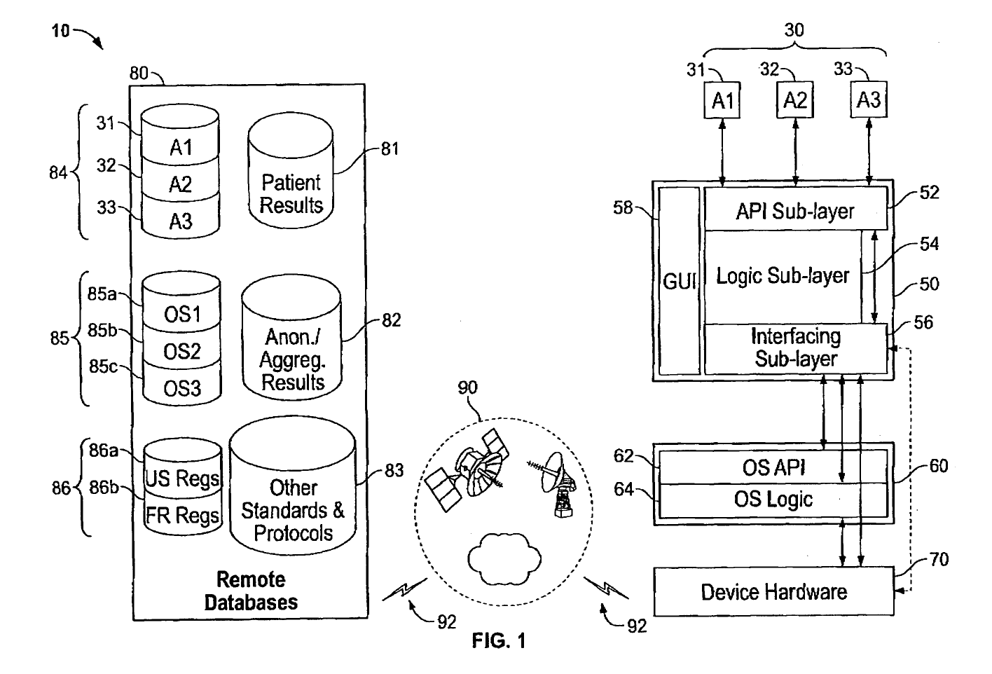

Referring to FIG. 1, there is generally depicted a schematic representation of a system 10 according to a preferred embodiment of the present invention. The system 10 preferably enables and/or facilitates the execution of third party applications (A1, A2, A3) 31, 32, 33 (alternately, referenced by “30”) in compliance with health data standards (e.g., including U.S. Regulations 86a and/or France Regulations 86b) and/or quality control protocols. Preferably, according to the invention, such applications 30 may be rendered capable of use in compliance with health, data, privacy, security, quality control, and/or other applicable protocols, standards, rules and/or regulations in the various jurisdictions where the executing devices are located.

FIG. 1 depicts an overarching layer of software code (alternately referred to herein as the “Launcher”) 50 which may be preferably provided in conjunction with the system 10 according to the invention. The Launcher 50 is shown functionally interposed between the underlying device operating system 60 (and its application programming interface, or “API” 62) and various applications 30 which may be coded therefor. The Launcher 50 is shown to include: the API sub-layer 52 to communicate with the applications 30; the logic sub-layer 54 to ensure the applications 30 comply with the requisite health, data, privacy, quality control, and/or jurisdictional protocols, standards, rules and/or regulations; the interfacing sub-layer 56 to communicate with the device and its operating system 60; and the Launcher graphical user interface (alternately “Launcher GUI”) 58 which is presented to a user following the start-up of the device, and through which the user's interactions with the applications 30, the device, and its operating system 60 are preferably mediated.

According to the invention, the health, data, privacy, security, quality control, and/or jurisdictional protocols, standards, rules and/or regulations which are appropriate—according to the device's location and intended use as a medical device—may be supplied to the logic sub-layer 54, when and/or as needed, from one or more remote databases 80 via the device.

In FIG. 1, the Launcher 50 is shown to intermediate communications between the various applications 30 and the device operating system (“OS”) 60. The system 10 preferably enables and/or facilitates the execution of the third party applications 30 coded for use in conjunction with a particular operating system 85a-c on devices provided with a different underlying operating system (e.g., the device OS 60). In this regard, and according to some preferred embodiments of the invention, the API sub-layer 52 may be provided with an ability to interface with applications 30 coded for use in conjunction with a first operating system (OS1) 85a, while the interfacing sub-layer 56 may be provided with an ability to interface with a second one (OS2) 85b. The API 52 and interfacing 56 sub-layers may be supplied with such abilities, when and/or as needed, from one or more remote databases 80 via the device.

According to the invention, the device's OS 60 may be canvassed to ensure compliance of the applications 30 with the appropriate operating system 85a-c. Thereafter, according to some preferred embodiments of the invention, the interfacing sub-layer 56 may be provided with the ability to interface with the appropriate device operating system 60.

According to the invention, the logic sub-layer 54 may afford some applications 30 the ability to access location services and/or the camera functionality of the device hardware 70, while denying such access to others. According to the invention, in certain situations—e.g., where a device's location may be sensitive and/or confidential, such as, when used by military or other organizations—the logic sub-layer 54 may securely disable all applications 30 from any ability to access the device's location services.

The Launcher 50 may selectively access the device OS API 62, the device OS logic 64 and/or the device hardware 70 (e.g., location services, camera functionality) directly.

As also shown in FIG. 1, the remote databases 80 may be accessed by the device over one or more wired or wireless communication networks 90, preferably wireless 92, including the Internet and satellite and terrestrial wireless, fiber optic or other networks. The remote databases 80 are shown to include a patient results database 81, an anonymized/aggregate results database 82, an application database 84, a Launcher OS version database 85, and a national regulations database 86, as well as databases of other standards, protocols, rules and regulations 83. Collectively, the other standards and protocols database 83 and national regulations database 86 comprise the appropriate health, data, privacy, security, quality control, and/or jurisdictional protocols, standards, rules and/or regulations 83,86. The application database 84 may contain, for example, the applications 30 and/or updates and/or other data corresponding to each one of the applications 31,32,33. According to the invention, the Launcher 50, the device with its underlying operating system 60, and/or various applications 30 may be served by one or more of these remote databases 80.

According to the invention, the remote databases 80 may take the form of one or more distributed, congruent and/or peer-to-peer databases which may preferably be accessible by the device over one or more of its regular wireless (and/or wired) communication networks 90, including terrestrial and/or satellite networks—e.g., the Internet and cloud-based networks.

Some of the relevant health, data, privacy, and/or security standards which applications 30 may not have been designed for, but which the present system 10 may preferably enable, may include compliance with one or more of the following (among others):
(a) The United States' Health Insurance Portability and Accountability Act of 1996 (or “HIPAA”). Generally and among other things, HIPAA may impose U.S. national standards for electronic health care transactions and national identifiers for providers, health insurance plans, and employers. HIPAA may also address the security and privacy of health data;
(b) The Health Level Seven (or “HL7”) framework and standards, which may provide for international healthcare informatics interoperability standards. HL7 may provide a framework (and related standards) for the exchange, integration, sharing, and retrieval of electronic health information, e.g., in support of clinical practice and the management, delivery, and evaluation of health services around the world;
(c) The Hypertext Transfer Protocol Secure (or “HTTPS”) communications protocol for secure communication over a computer network. HTTPS may provide for bidirectional encryption of communications between a client and server, and/or for protection against eavesdropping and tampering with and/or forging the contents of the communication;
(d) The Point-of-Care Connectivity (or “POCT1”) standard for point-of-care diagnostic devices, and the hardware and software used to connect the devices to various information systems in healthcare facilities and otherwise. POCT1 may provide specifications for point-of-care device and information system communication interoperability, and/or the basis for multivendor, seamless interoperability between point-of-care devices, data managers, and/or clinical results management systems, among others;
(e) The Digital Imaging and Communications in Medicine (or “DICOM”) standard for handling, storing, printing, and/or transmitting information in medical imaging. DICOM may include a file format definition and a network communications protocol, and may use TCP/IP to communicate between systems, allowing DICOM files to be exchanged between two entities that are capable of receiving image and patient data in DICOM format. DICOM may enable integration of scanners, servers, workstations, printers, and/or network hardware from multiple manufacturers into a picture archiving and/or communication system.

According to some preferred embodiments of the invention, the device's location services may be canvassed to ensure compliance of the application 30 with the appropriate protocols, standards, rules and/or regulations. Thereafter, according to the invention, the appropriate health, data, privacy, security, quality control, and/or jurisdictional protocols, standards, rules and/or regulations 83,86 may be supplied to the logic sub-layer 54 from the national regulations database 86 and/or other standards & protocols database 83.

The system 10 according to the invention may preferably enable the compliance of applications 30 with quality control standards and/or protocols, such as, for example, in vitro diagnostic (or “IVD”) protocols (not shown). That is, and by way of a non-limiting example, the present invention may apply IVD protocols to the workflows otherwise executed by one or more applications 30. Of course, other quality control protocols and/or standards may be applied by the system 10 according to the invention in mediating communication between the applications 30, the device, and its operating system 60 (and/or otherwise).

According to the invention, when and as necessary, the system 10 may sometimes anonymize at least a portion, and in some cases, all identifying patient data for compliance with one or more of the appropriate health, data, privacy, and/or security standards 83,86.

Advantageously, and among other things, applications 30 which might otherwise offend and/or violate applicable health, data, privacy, security, quality control, and/or jurisdictional protocols, standards, rules and/or regulations 83,86 may be rendered compliant therewith. Similarly, applications 30 which might otherwise be inoperable with a particular device operating system 60 may be rendered operable therewith.

Preferably, the remote databases 80 may also be designed to securely store the patient results 81. When appropriate, the complete patient results 81 may be stored in the remote databases 80 and accessible, e.g., by the physician attending at the point-of-care who originally collected them. In other situations, only anonymized patient data (or aggregated and anonymized patient results 82) may be separately stored in and accessible from the remote databases 80.

The remote databases 80 may store various different jurisdictional logic sets for compliance with protocols, standards, rules and/or regulations which may be applicable in different jurisdictions (e.g., for compliance with the protocols, standards, rules and/or regulations which are applicable in the United States 86a as compared with those applicable in France 86b).

The remote databases 80 may store various versions of the overarching layer of software code 50—e.g., including versions which may be provided with an interfacing sub-layer 56 that is adapted for use with a particular device operating system 60. It is contemplated that other versions of the overarching layer of software code 50 may include an interfacing sub-layer 56 that is adapted for use with more than one device operating system 85a-c.

Still further, the remote databases 80 may store and provide to the devices various applications 31,32,33 which are capable of use together with the system 10 according to the present invention.

As shown in FIG. 1, the API sub-layer 52 communicates and/or exchanges data with the various applications (A1, A2, A3) 31, 32, 33.

Persons having ordinary skill in the art should appreciate from FIG. 1 that different Launcher OS versions 85a-c may be served from the remote databases 80, preferably depending at least in part upon the device OS 60 and/or upon the OS for which one or more of the various applications (A1, A2, A3) 31, 32, 33 may have been written. The different Launcher OS versions 85a-c may affect the working of the Launcher's API sub-layer 52 and/or its interfacing sub-layer 56, among other things. According to some embodiments of the invention, the API Sub-layer 52 of the Launcher 50 may interface with applications 30 coded for use in conjunction with a first operating system (OS1) 85a, while the Launcher's interfacing sub-layer 56 may interface with a second one (OS2) 85b. Still further, some versions of the Launcher 50 may include an interfacing sub-layer 56 that is adapted for use with more than one device OS 60. The different Launcher OS versions 85a-c may so affect the working of the API sub-layer 52 and interfacing sub-layer 56 when and/or as needed. Applications 30 which might otherwise be inoperable with a particular device OS 60 may be rendered operable therewith.

Similarly, persons having ordinary skill in the art should appreciate from FIG. 1 that different protocols, standards, rules and/or regulations 83,86 may be served to the Launcher 50 from the remote databases 80. The different standards and protocols 83,86 may affect the working of the logic sub-layer 54. As shown in FIG. 1, the logic sub-layer 54 preferably may be functionally interposed between the API sub-layer 52 and the interfacing sub-layer 56, and ensures the application 30 complies with the requisite health, data, privacy, quality control, and/or jurisdictional protocols, standards, rules and/or regulations 83,86. For example, one or more jurisdictional databases (alternately “national regulations databases”) 86 of the remote databases 80 may store jurisdictional logic sets for compliance with protocols, standards, rules and/or regulations 86 which may be applicable in different jurisdictions (e.g., for compliance with the protocols, standards, rules and/or regulations which are applicable in the United States 86a, as shown in FIG. 1, as compared with those applicable in France 86b). Likewise, one or more other standard and protocol databases 83 may store other standard and protocols (e.g., for compliance with the HIPAA, HL7, HTTPS, POCT1 and/or DICOM standards). The appropriate protocols, standards, rules and/or regulations 83,86 may be supplied to the logic sub-layer 54, when and/or as needed, from the remote databases 80 via the device.

If, when and as appropriate (and as shown in FIG. 1), the API sub-layer 52 may communicate and exchange data with the interfacing sub-layer 56, without passing such communication and/or data through the logic sub-layer 54 of the Launcher 50.

The interfacing sub-layer 56 communicates and/or exchanges data with the device and its operating system 60. In some cases, and as shown in FIG. 1, the interfacing sub-layer 56 communicates and/or exchanges data, directly and/or indirectly, with the API 62 or logic 64 of the OS and/or with the device hardware 70. As shown in FIG. 1, the API 62 and/or logic 64 of the OS (and/or the whole OS 60) may pass through such communication and/or data as between the device hardware 70 and the interfacing sub-layer 56. Alternately, and as also shown in FIG. 1, the interfacing sub-layer 56 may, directly, communicate and/or exchange data with the device hardware 70, when possible and required and/or desired. For example, in some embodiments, the Launcher 50 may access particular components of the device hardware 70 (e.g., the device camera) to provide for configuration and/or operation of those device hardware 70 components. Some users of the Launcher 50 and/or the remote databases 80, and/or some application manufacturers, may desire, prefer and/or require the Launcher 50 to circumvent the device OS 60 (e.g., by having the Launcher's interfacing sub-layer 56, directly, communicate and/or exchange data with the device hardware 70) in certain situations and, accordingly, the Launcher 50 may be adapted to do so.

When appropriate, the complete patient results may be stored in and accessible from, preferably on a restricted basis, one or more patient results databases 81 of the remote databases 80 (as shown in FIG. 1), e.g., by a physician attending at the point-of-care, or by the patient, who originally collected them.

When and as necessary, the logic sub-layer 54 of the Launcher 50 may anonymize at least a portion, and in some cases, all identifying patient data for compliance with one or more of the appropriate health, data, privacy, and/or security standards 83,86. The anonymized data may then be separately stored in and accessible from one or more aggregated and anonymized patient databases 82 of the remote databases 80 (as shown in FIG. 1). In some embodiments of the invention, the Launcher 50 may not be responsible for anonymizing the patient data, but only for accessing it from the aggregated and anonymized patient databases 82 of the remote databases 80. Other embodiments will perform only the anonymizing function (but not the accessing one) and others will perform both of these functions.

From the description and figures, diagrams and screenshots provided herein, persons having ordinary skill in the art should appreciate the Launcher 50 may preferably, but need not necessarily, be adapted to act as follows:
1) as an OS emulator for applications 30 (e.g., providing for proper execution of Android apps (A1) 31 and (A2) 32 on a device provided with a Windows OS 60);
2) as OS itself for compliant applications 30 (e.g., directing control of the device hardware 70 on behalf of a Windows app (A3) 33; and/or
3) as intermediary between the OS-compliant apps 30 and the device OS 60: controlling access, anonymizing data and/or implementing medical communication protocols and/or encrypted data transfer standards if, when and as required.

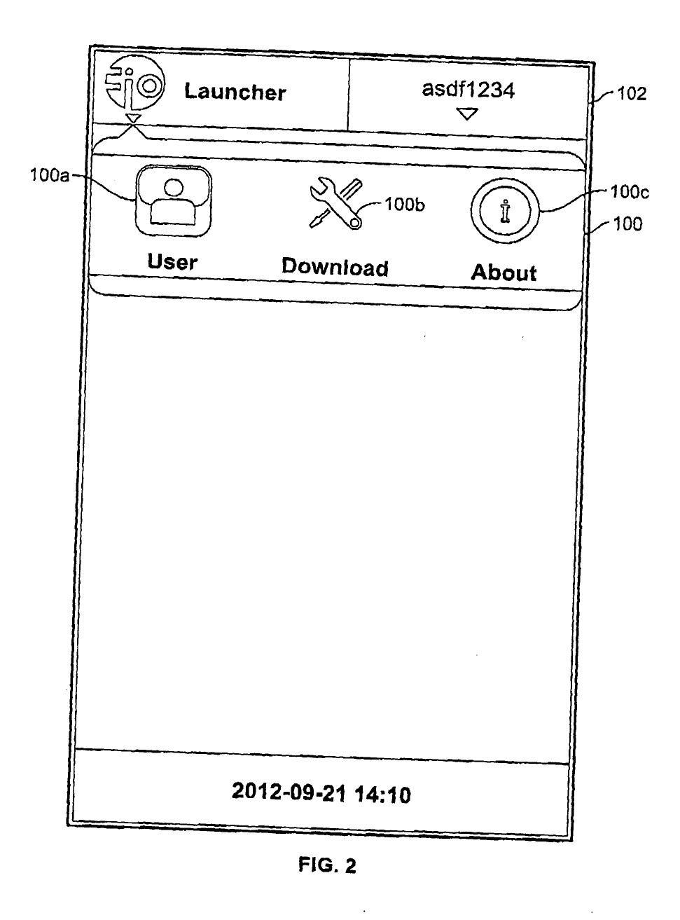

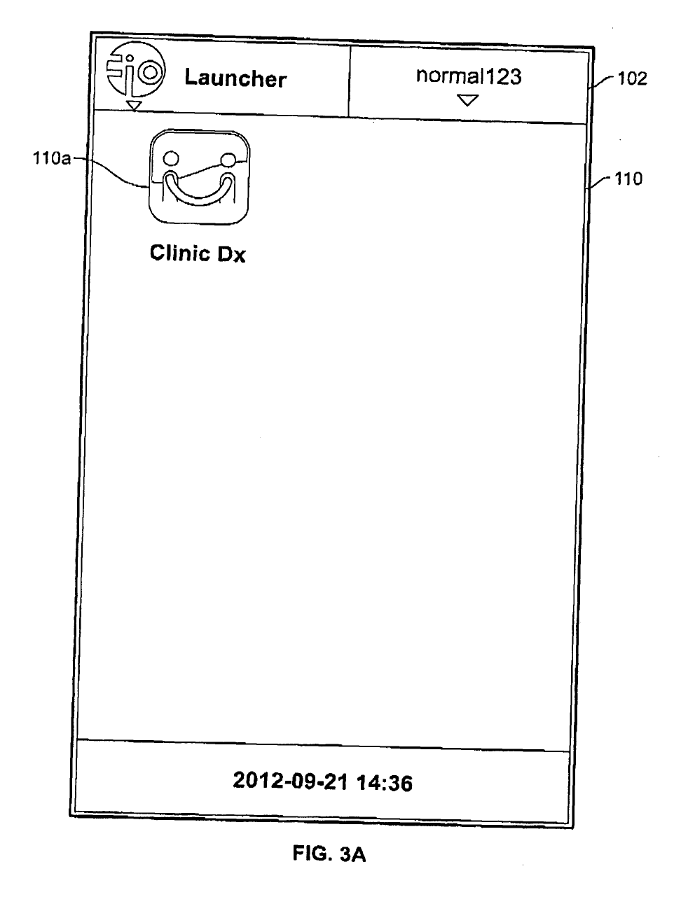

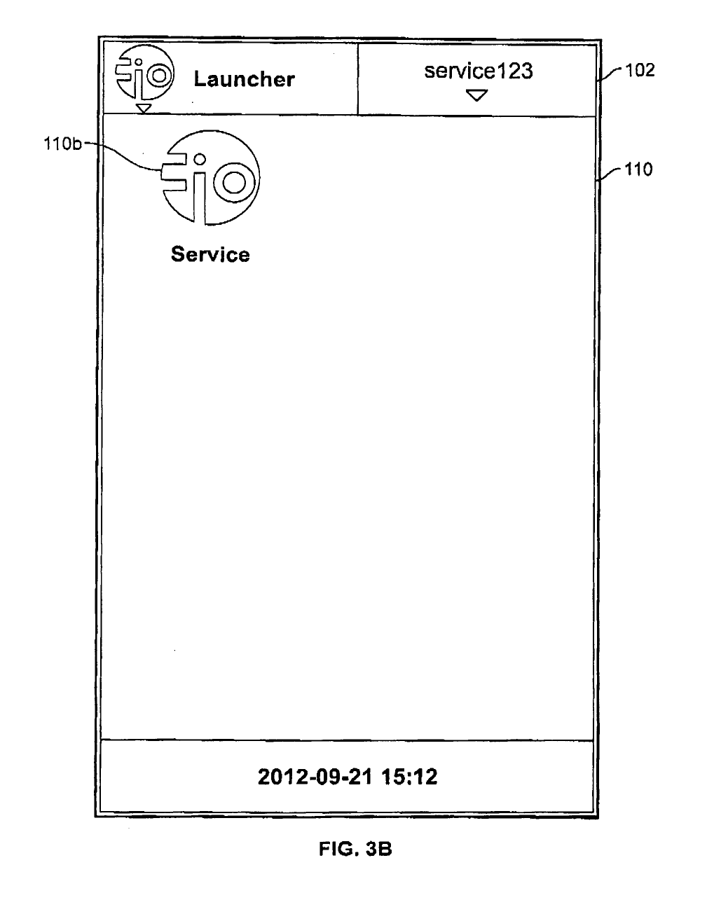

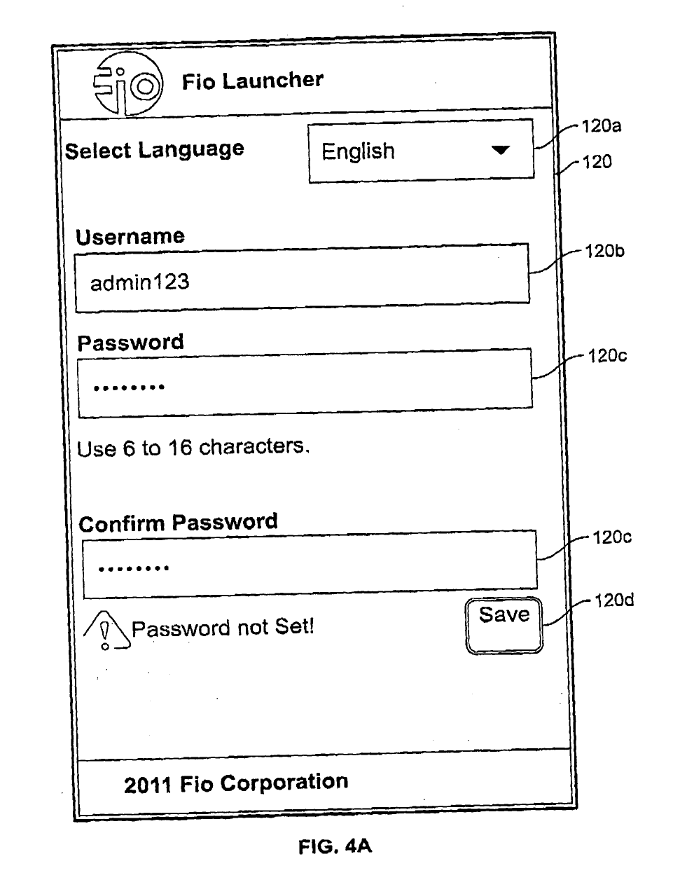

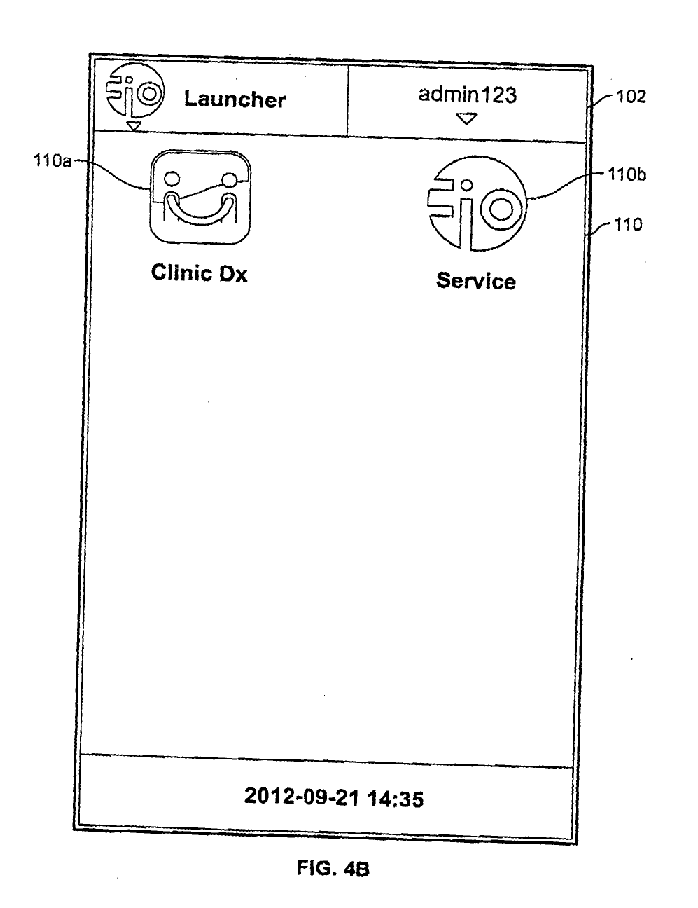

FIGS. 2 through 4B illustrate examples of one preferred embodiment of a Launcher touchscreen GUI 58. Persons having ordinary skill in the art will notice the Login screen (alternately “user login window”) 100. Preferably, depending on the credentials entered, after login a user may see only the applications 30 they are allowed to see. For example, a normal user may see a ClinicDx icon 110a to start the ClinicDx application only (as depicted in FIG. 3A), whereas a service user may see a Service icon 110b to start the service application only (as depicted in FIG. 3B), and an admin user may see both the ClinicDx icon 110a and the Service icon 110b to start the ClinicDx and Service applications respectively (as depicted in FIG. 4B).

According to some preferred embodiments of the invention, there may be no way for the user to go beyond the Launcher screens and get to any setup screens of the device OS (e.g., of the Android operating system). Preferably, for example, the Launcher 50 may be invoked when the user touches a “Home” hardware button (not shown) which may be provided as part of the device.

Still with reference to FIGS. 2 through 4B, when a user touches the ClinicDx icon 110a for the ClinicDx application or the Service icon 110b for the Service application, that application may preferably be started.

More particularly, FIG. 2 illustrates a “User” icon 100a, within a user login window 100, to select a user (e.g., a normal user, service user, administrative user, etc.). Preferably, the user login window 100 may also include a download icon 100b (e.g., downloading various software updates) and an information icon 100c (e.g., for providing instructions for the user, information about the applications 30, etc.). A user information window 102 may also be provided to display the current user information (e.g., a normal user, service user, administrative user, etc.).

FIG. 3A illustrates how the GUI may preferably appear after login by a normal user. For the normal user, the application selection window 110 may preferably show the ClinicDx icon 110a. The user information window 102 confirms the normal user status. FIG. 3B shows how the GUI may preferably appear after login by a service user. For the service user, the application selection window 110 may preferably show the service icon 110b. The user information window 102 confirms the service user status.

FIG. 4A depicts a login screen (alternately an “administrative user login window”) 120 for an administrative (or “admin”) user. This window 120 preferably presents the admin user with additional requests, including language selection 120a from a drop-down menu, username entry 120b, and/or password entry 120c. Once the admin user has responded to the additional requests, a confirmation (or “save”) icon 120d may be selected. FIG. 4B illustrates how the GUI may preferably appear after login by an admin user. For the admin user, the application selection window 110 may preferably show the ClinicDx icon 110a and the service icon 110b. The user information window 102 confirms the service user status.

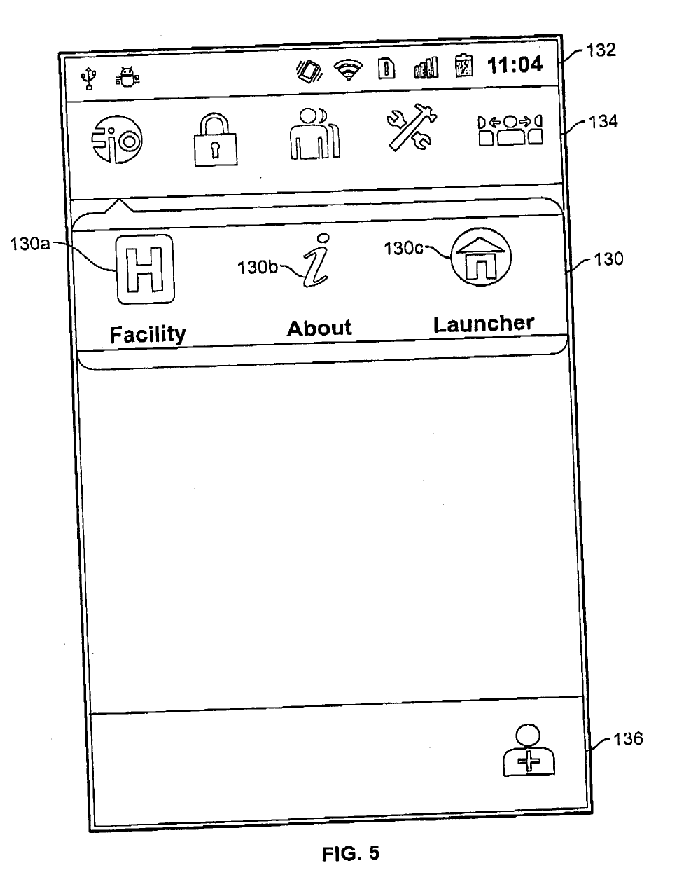

FIG. 5 through 15S illustrate examples of another preferred embodiment of the Launcher touchscreen GUI. These examples may present substantially the same ideas (or one or more of them), with revised graphics. As before, normal users may preferably see only those applications 30 which normal user credentials authorize them for—e.g., one application called the Clinic Dx application.

From a Quick Launcher screen (or “Quick Launcher window”) 130 (as shown in the figures), skilled persons may appreciate how to get from the Clinic Dx application back to the Launcher home screen—e.g., by selecting a Launcher icon 130c (as shown in FIG. 5) or by selecting the “Home” hardware key, as before. More particularly, FIG. 5 illustrates how the GUI for the Quick Launcher window 130 may preferably appear. Specifically, the Quick Launcher window 130 may include a facility icon 130a (e.g., to provide information about a given facility), an information icon 130b, and a launcher icon 130c. In addition, a status bar 132 may also be provided (e.g., includes information such as, but not limited to, wireless signal strength, current time, battery power remaining, etc.) along with a setup window 134 (e.g., includes options such as, but not limited to, device lock, user preferences, data sharing, etc.). An action window 136 provides for the addition of new patients.

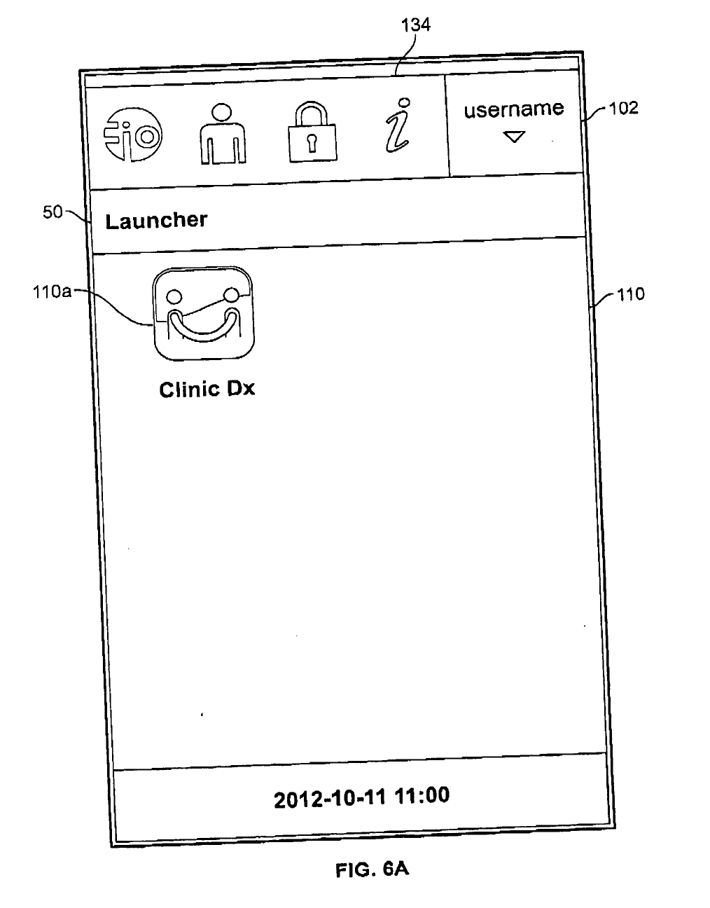

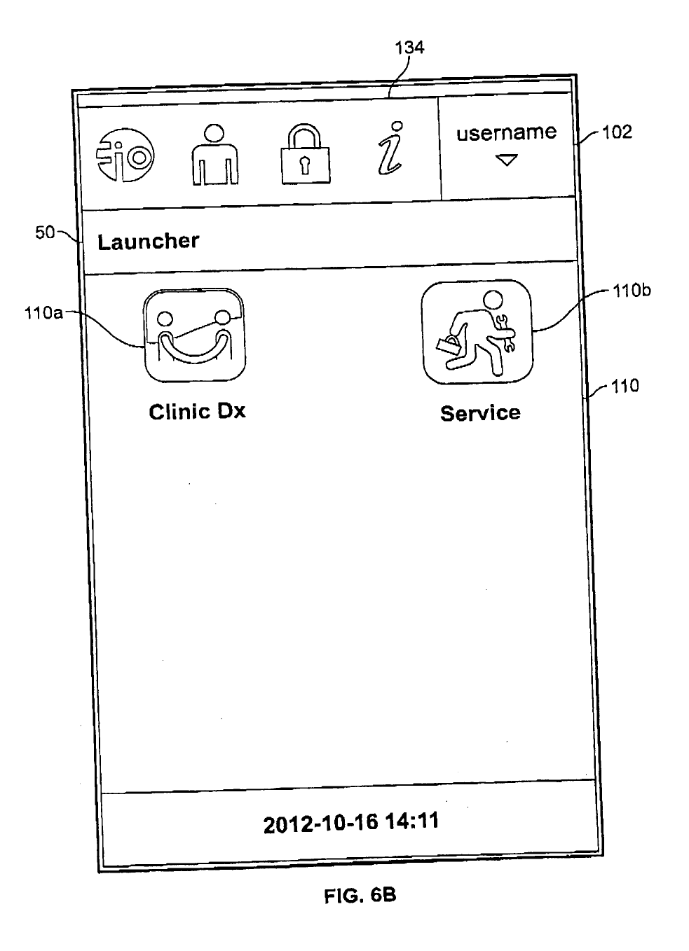

FIG. 6A illustrates how a first Launcher home screen of the GUI may preferably appear to a normal user on the Launcher 50. The application selection window 110 includes the ClinicDx icon 110a. The user information window 102 confirms the username and a setup window 134. A second Launcher home screen (shown in FIG. 6B), shows what a user with an admin access level may preferably see on the Launcher 50. The application selection window 110 includes the ClinicDx icon 110a and the service icon 110b. Similar to before, the user information window 102 confirms the username and a setup window 134.

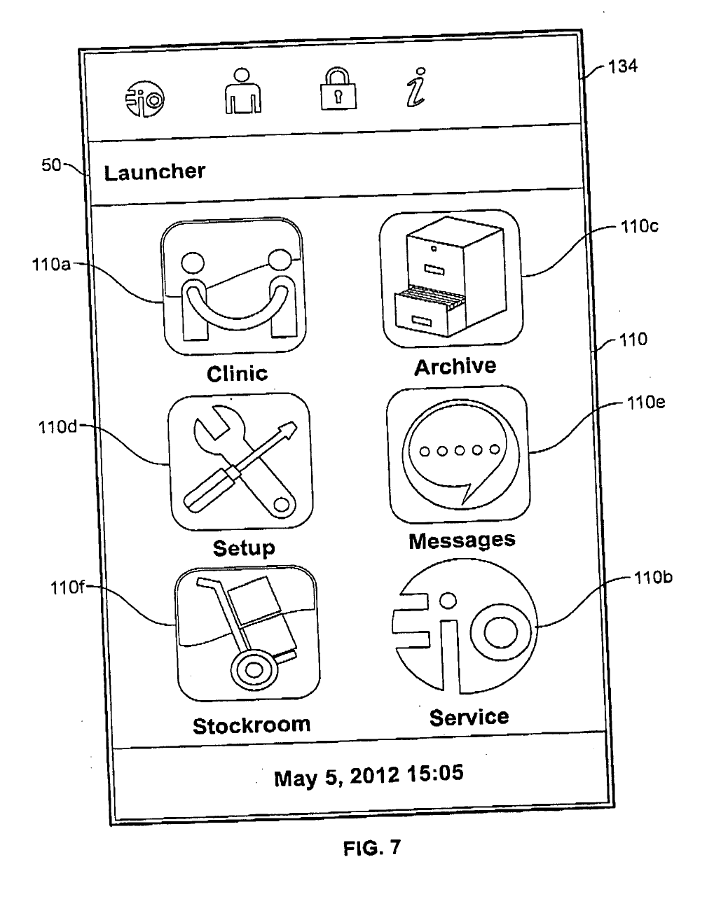

FIG. 7 shows a representation of how the Launcher GUI may preferably look if there are many applications installed on the Launcher 50. Arranged in the application selection window 110 are the following: clinic icon 110a; service icon 110b; archive icon 110c (e.g., for saving selected information and/or data); setup icon 110d; messages icon 110e (e.g., for sending a message to another user); and stockroom icon 110f (e.g., for retrieving selected information and/or data). A setup window 134 may also be provided.

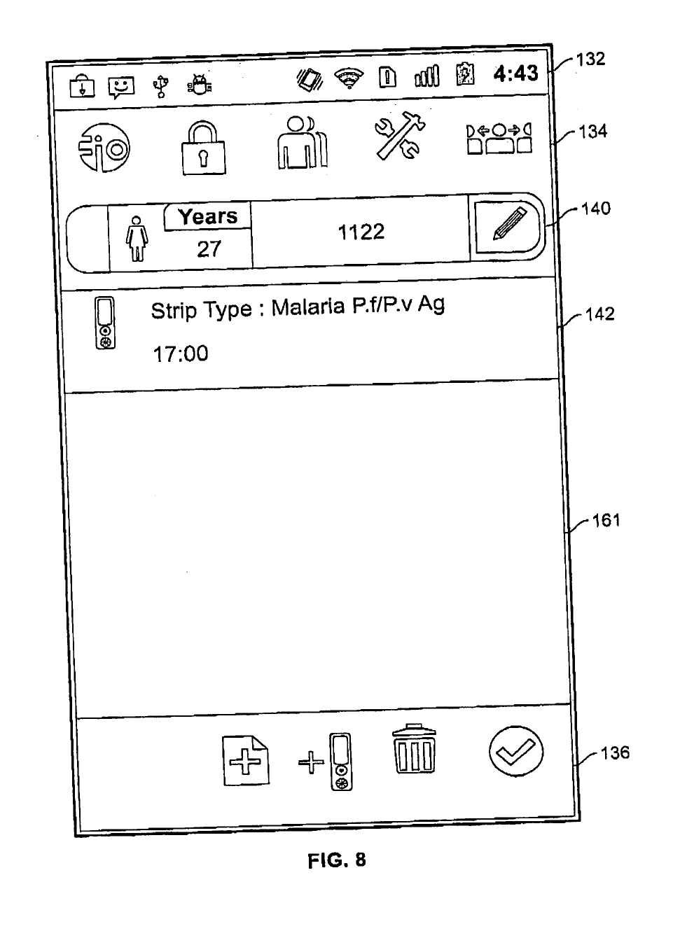

FIG. 8 shows how a patient home screen (or “patient home window”) 161 of the GUT may appear with a test. In particular, a patient information window 140 may be presented to display the gender, age, and ID number of a given patient. A test information window 142 may also be provided to present relevant test information (e.g., strip type). As before, a status bar 132 and setup window 134 may also preferably be provided. For the patient home window 161, the action window 136 preferably provides for various additional options (e.g., confirming the patient selected, deleting the patient selected, adding one or more tests to associate with the patient selected, etc.).

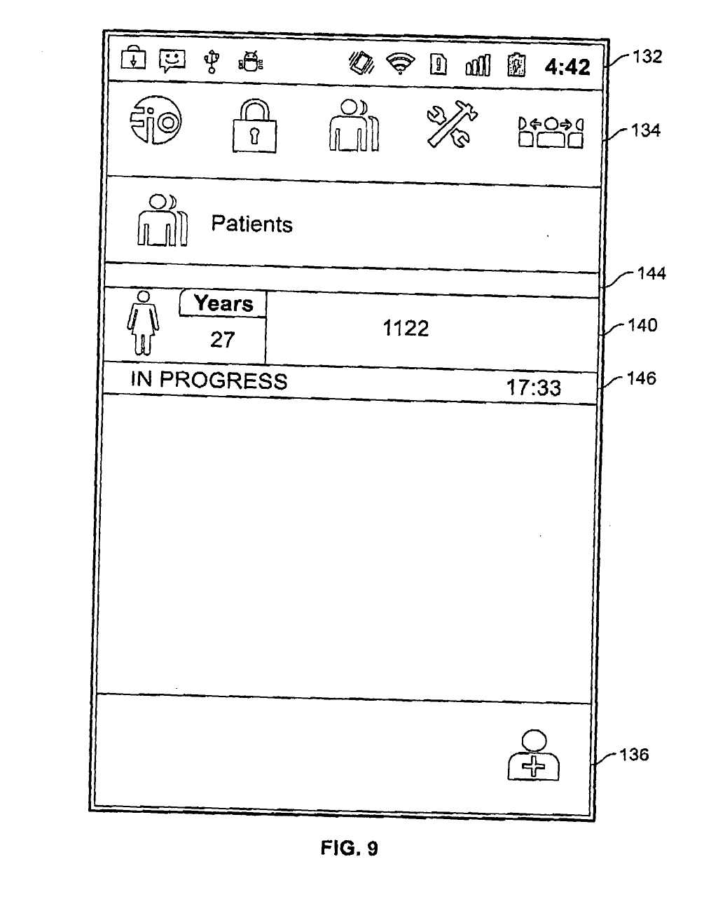

FIG. 9 illustrates how patients with tests may be shown on a patient manager screen (or “patient manager window”) 144 of the GUI. As before, the patient information window 140 may be presented to display the gender, age, and ID number of a given patient. Patient test status 146 may also be provided to show, for example, the status of a particular test and the time to test completion. Also as before, the status bar 132 and setup window 134 may be provided. In addition the action window 136 may be provided for the addition of new patients.

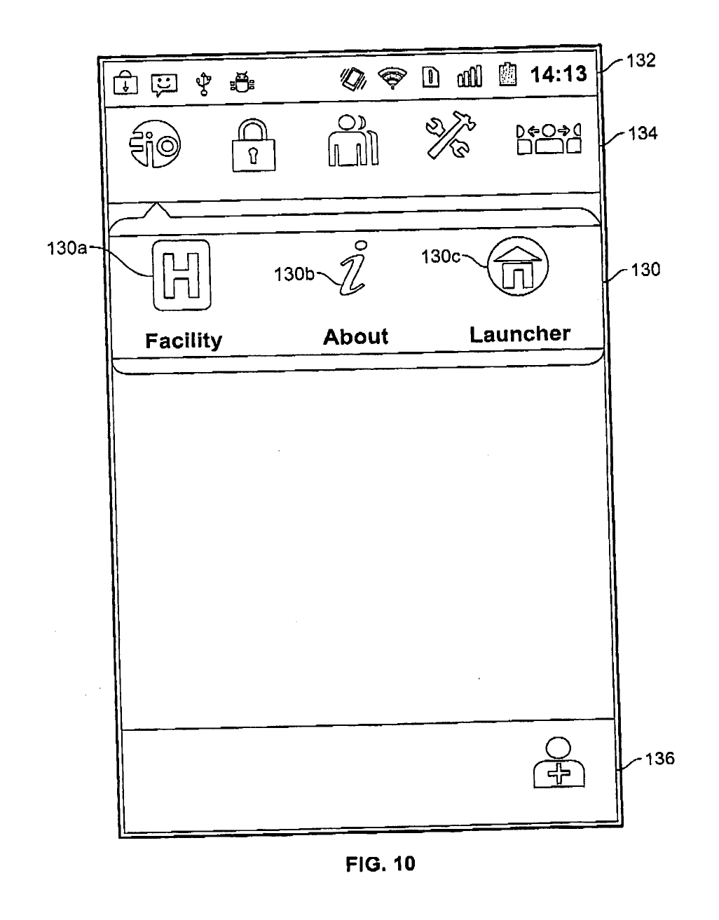

FIG. 10 shows how the Quick Launcher Menu 130 for the Clinic Dx application may appear in the GUI. Similar to before, the facility icon 130a, information icon 130b, and launcher icon 130c may be provided within the Quick Launcher Menu 130. Also as before, the status bar 132 and setup window 134 may be provided. In addition the action window 136 may be provided for the addition of new patients.

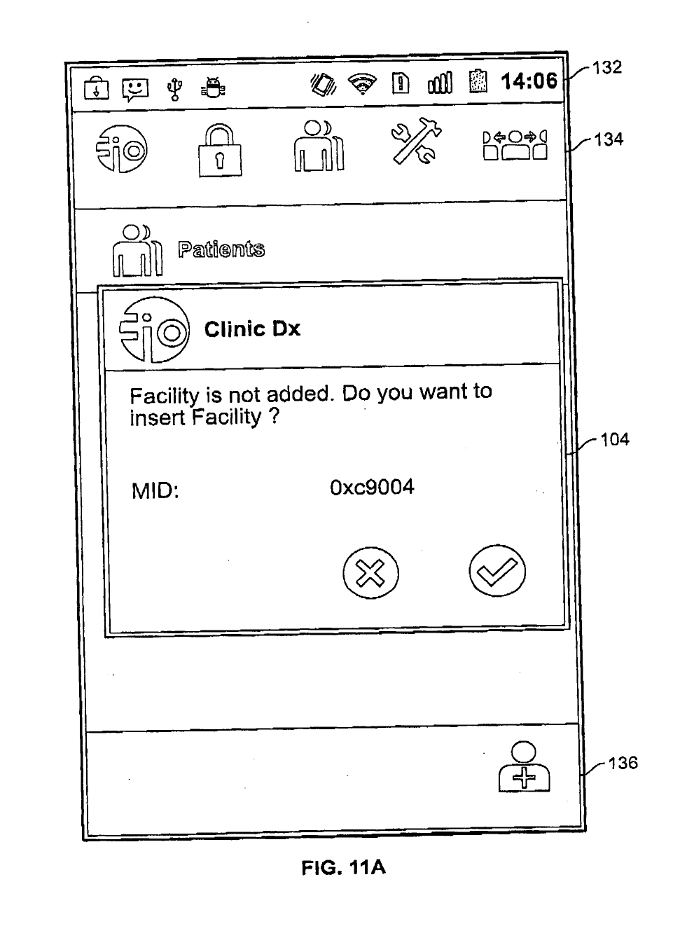

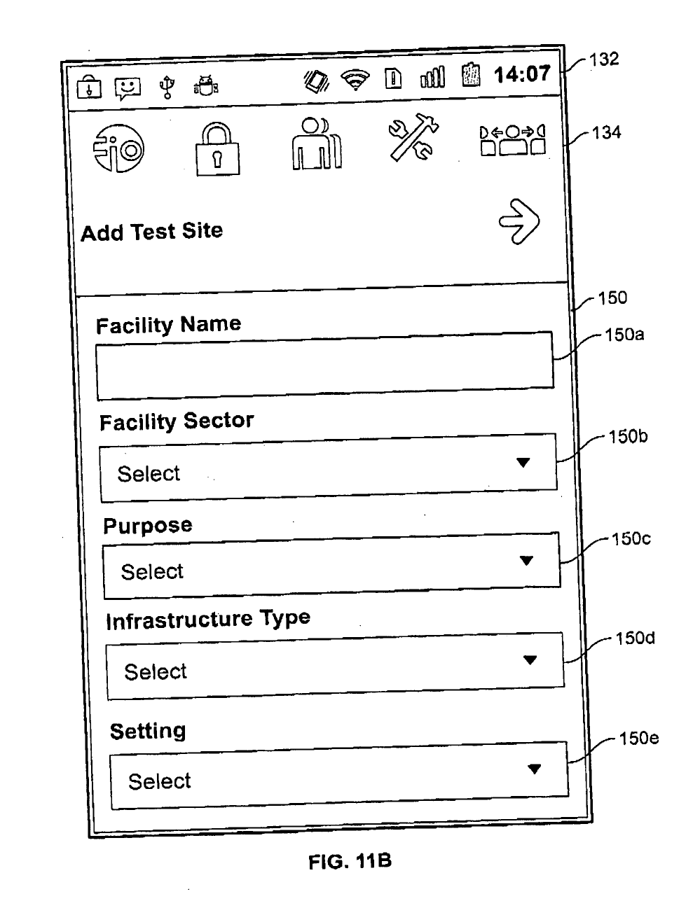

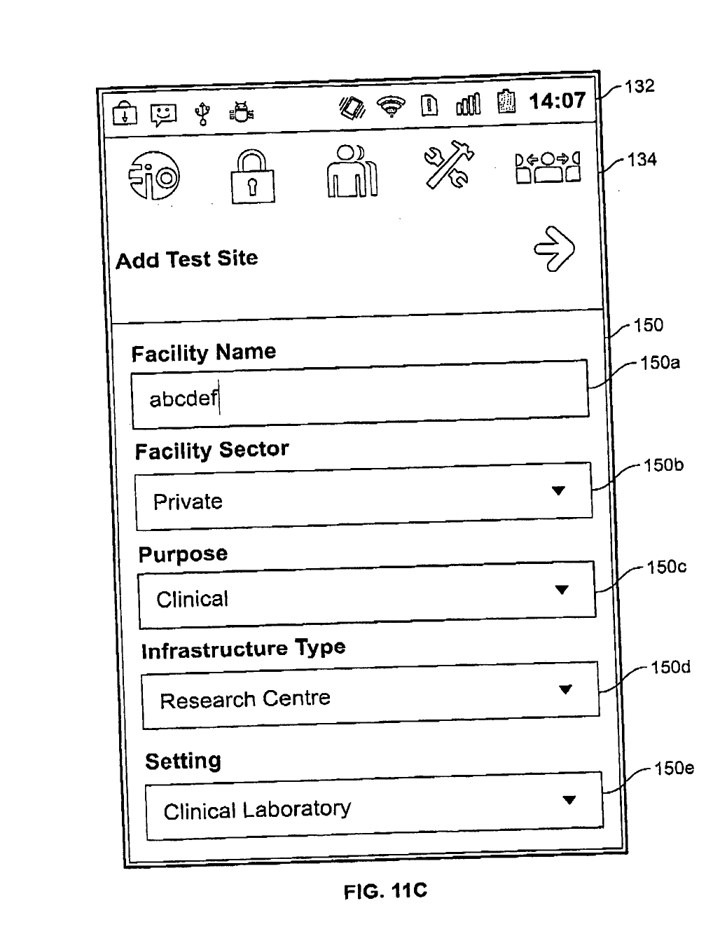

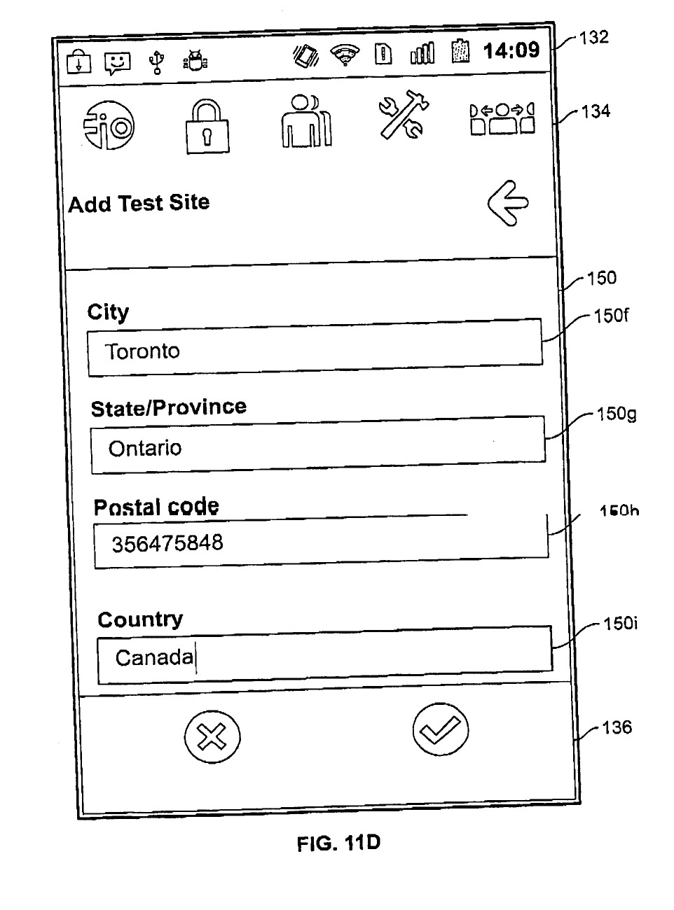

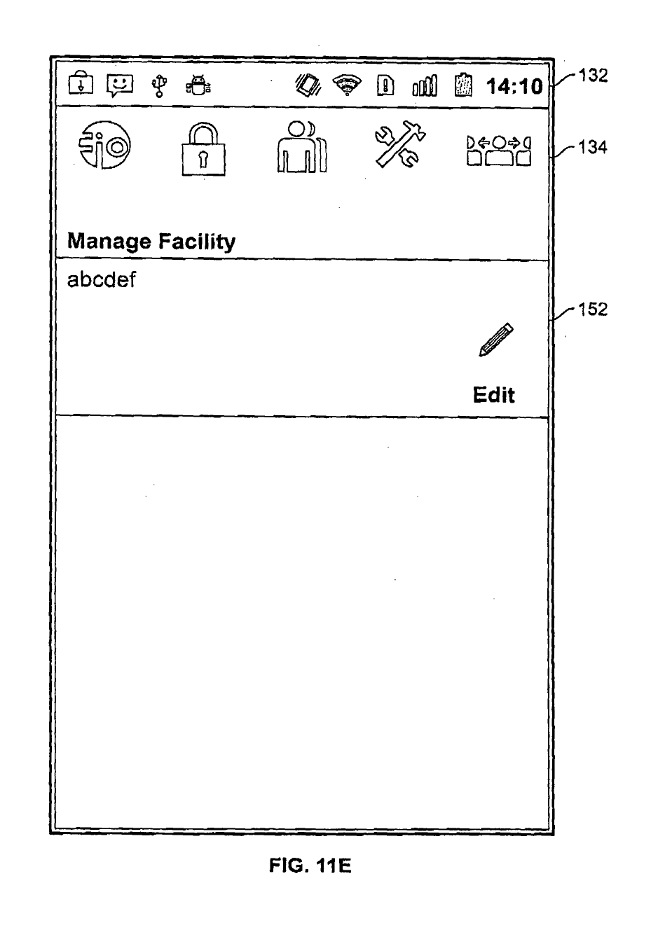

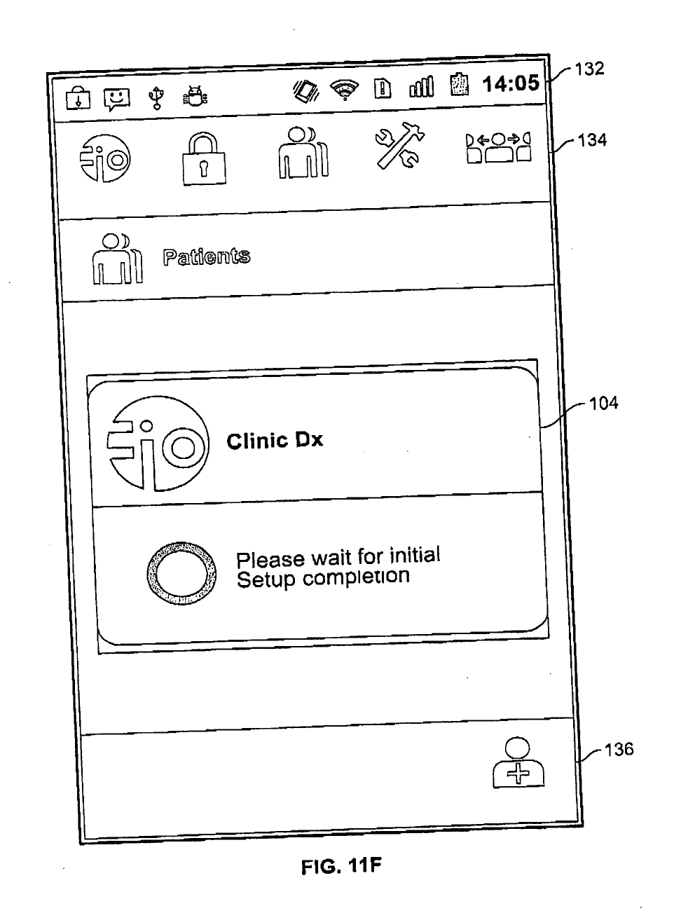

Still further, the figures illustrate GUI screen images for various functions and menus which might be navigated by a user. More particularly, FIGS. 11A through 11F illustrate how “FACILITY” functions and menus might be navigated by the user. FIG. 11A shows how a facility (alternately a “test site”) notification dialog window might appear in the GUI. In particular, a dialog window 104 may indicate, for example, that a particular test site has not been added and may provide an option to add the test site. In this regard, the dialog window 104 may be provided with similar functionality to the action window 136, in that it allows for the user to proceed, or not proceed, with the addition of the test site. As before, the status bar 132 and setup window 134 may be provided. In addition the action window 136 may be provided for the addition of new patients.

FIGS. 11B through 11D illustrate how a facility and its details might be added to/entered for the Launcher. FIG. 11B depicts an add test site window 150 which preferably presents the user with additional requests, including test site name entry 150a, facility sector selection 150b from a drop-down menu (e.g., private, public), purpose selection 150c from a drop-down menu (e.g., clinical, research), infrastructure type selection 150d from a drop-down menu (e.g., research centre, corporation, private clinic), and/or setting selection 150e from a drop-down menu (e.g., clinical laboratory, field collection).

FIG. 11C shows the add test site window 150 wherein the user has responded to each of the additional requests related to the added test site.

FIG. 11D shows the add test site window 150 presenting the user with further requests, including city entry 150f, state/province entry 150g, postal code entry 150h, and country entry 150i. The action window 136 provides the user the option of confirming the responses to the additional requests related to the added test site. As before, for each of FIGS. 11B to 11D, the status bar 132 and setup window 134 may be provided.

FIG. 11E illustrates how a “manage facility” screen (alternately “manage facility window”) 152 might be shown in the GUI. The window 152, may for example provide the user with an option to edit test site information.

FIG. 11F shows how the Clinic Dx application might be initialized and configured in connection with the “FACILITY” functions. The dialog window 104 may, for example, provide a message to the user that the application is initializing. The action window 136 provides the user with an option to add additional patients. As before, for each of FIGS. 11E and 11F, the status bar 132 and setup window 134 may be provided.

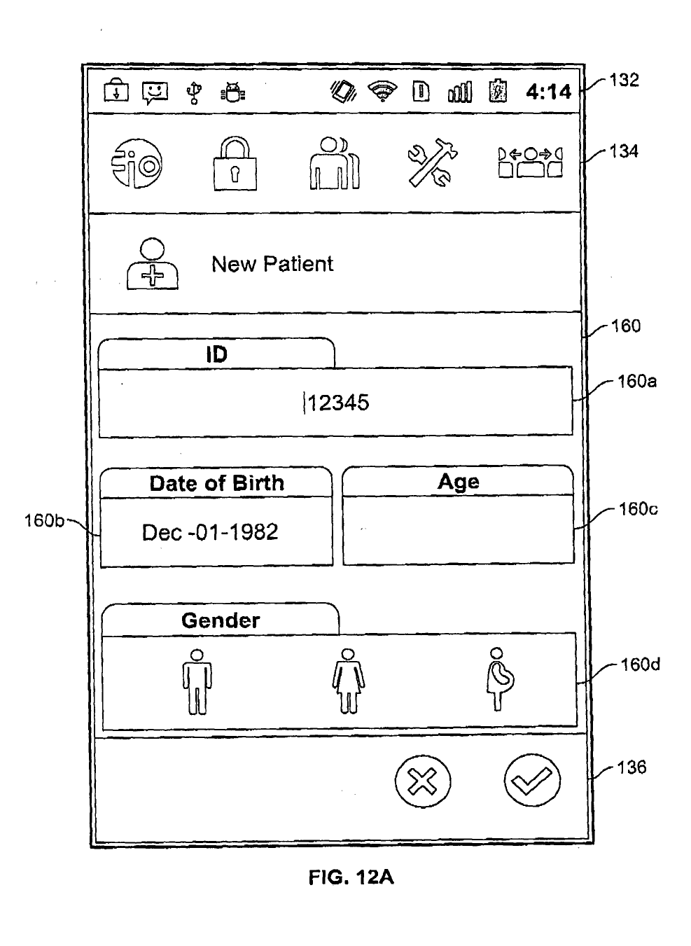

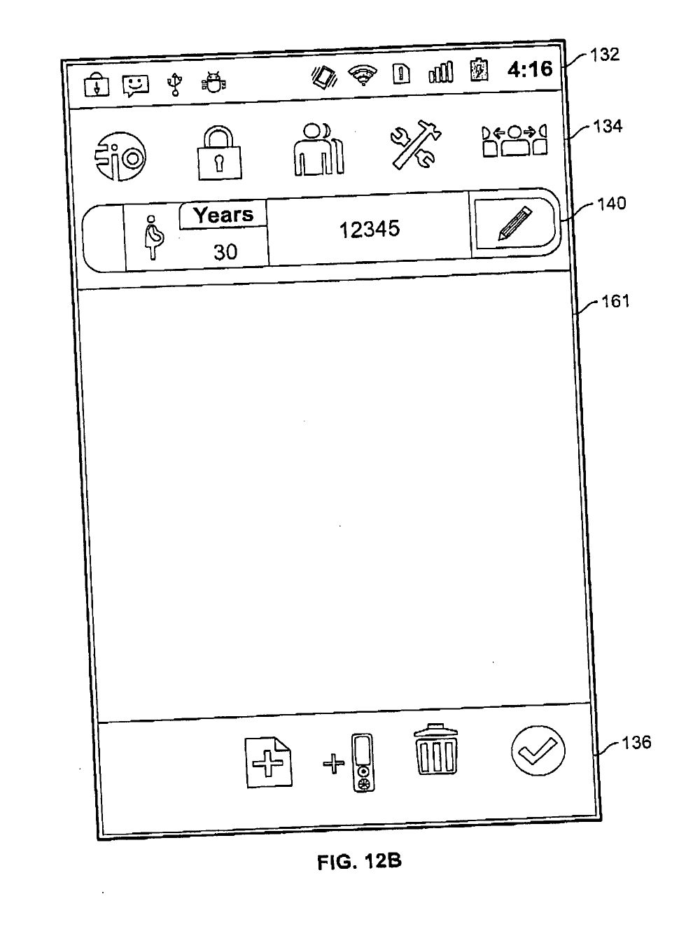

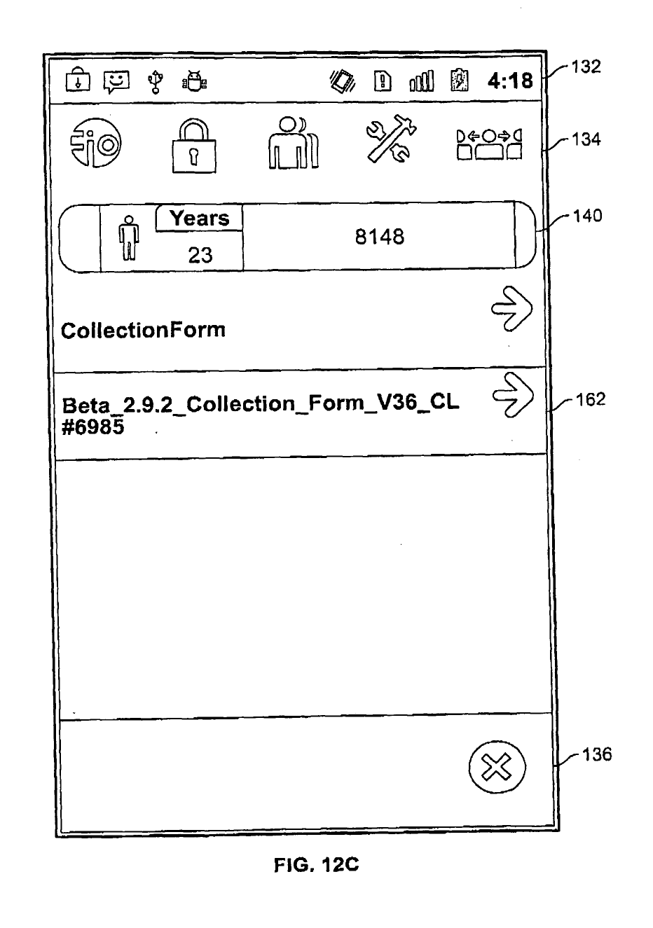

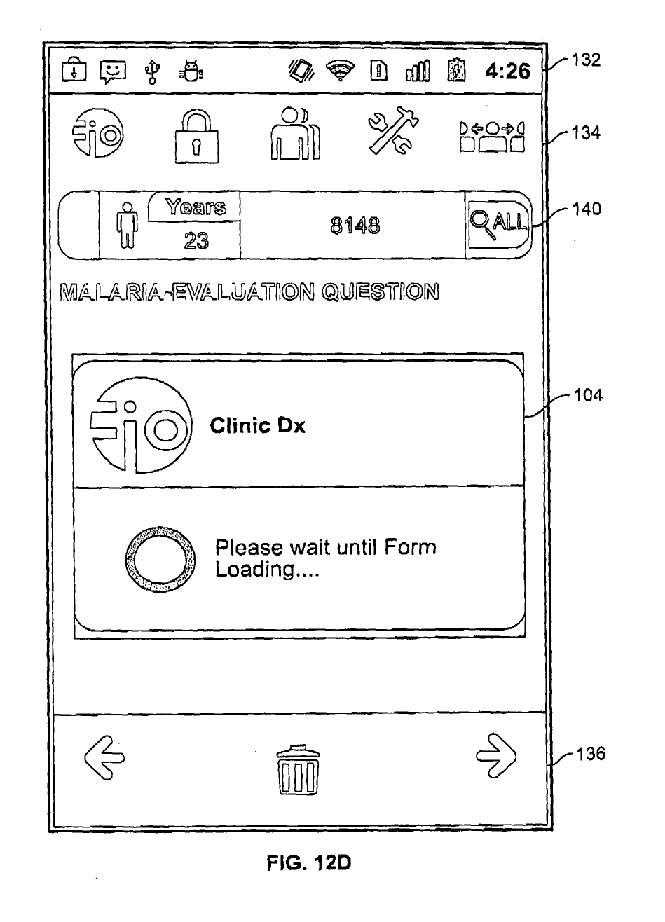

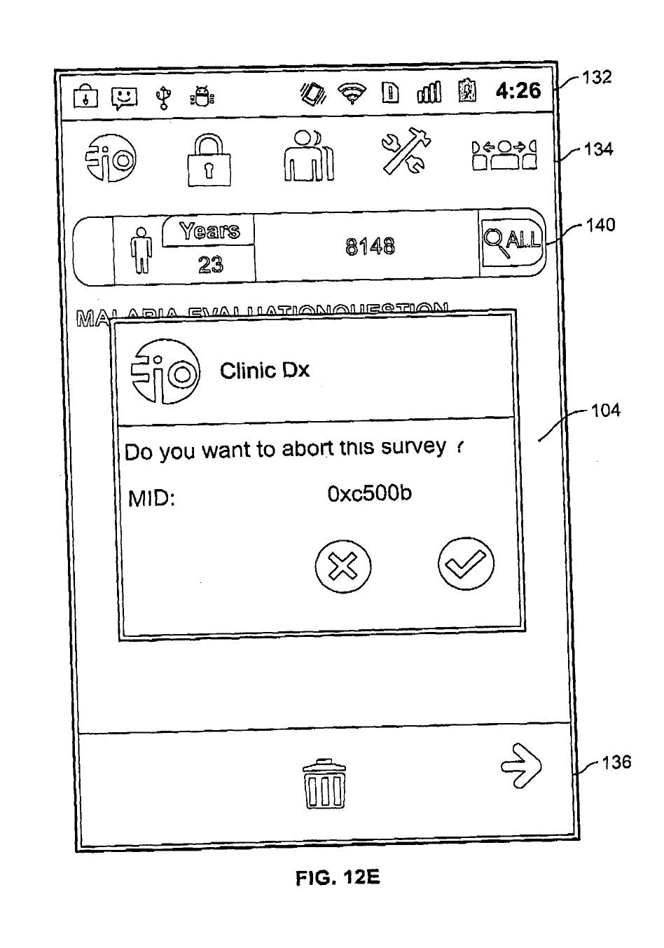

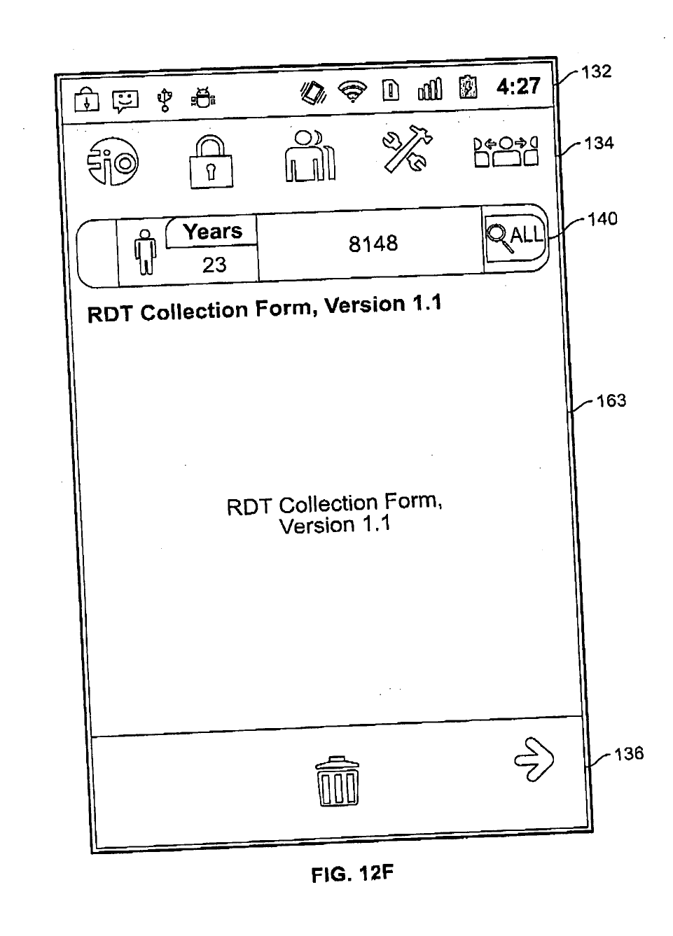

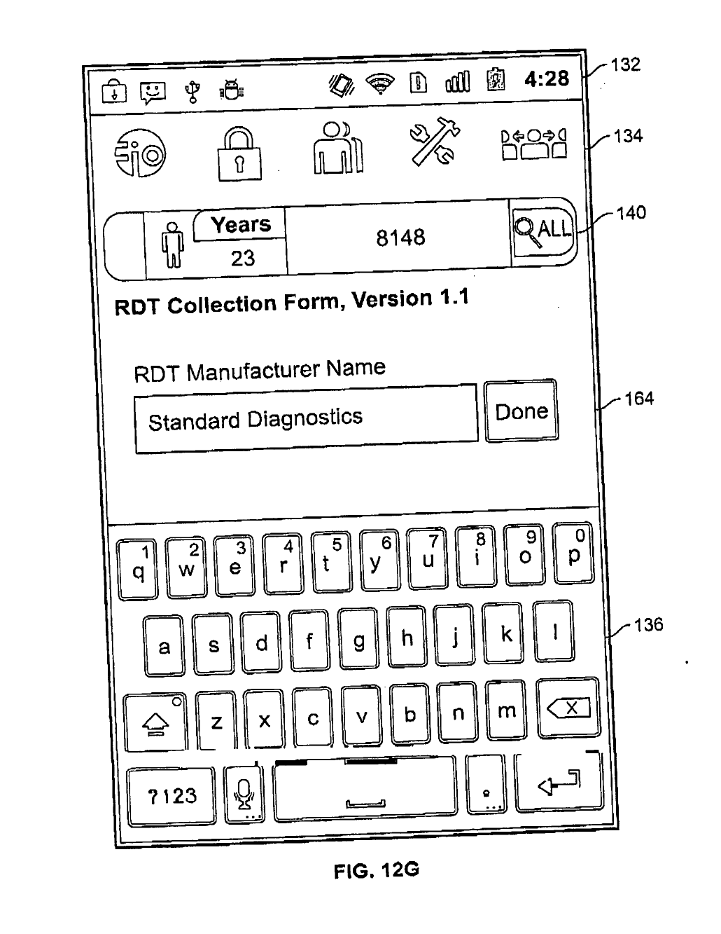

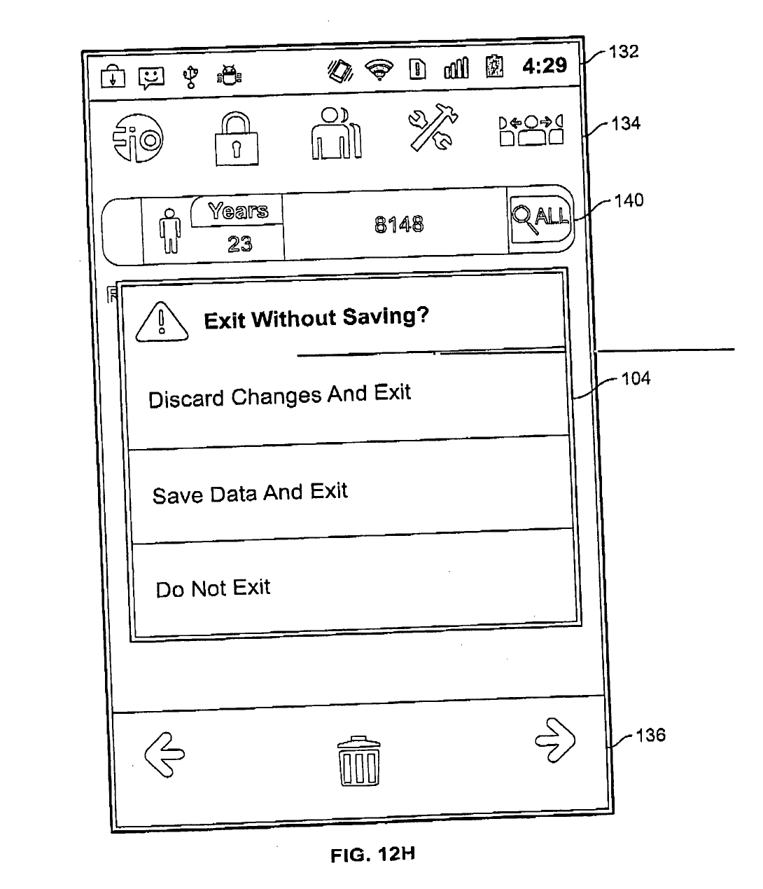

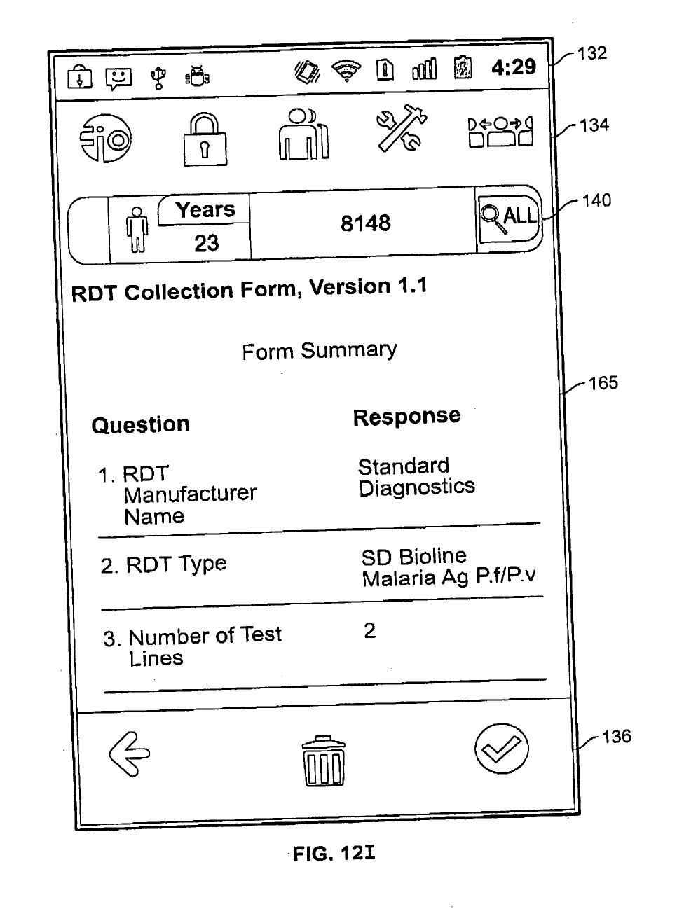

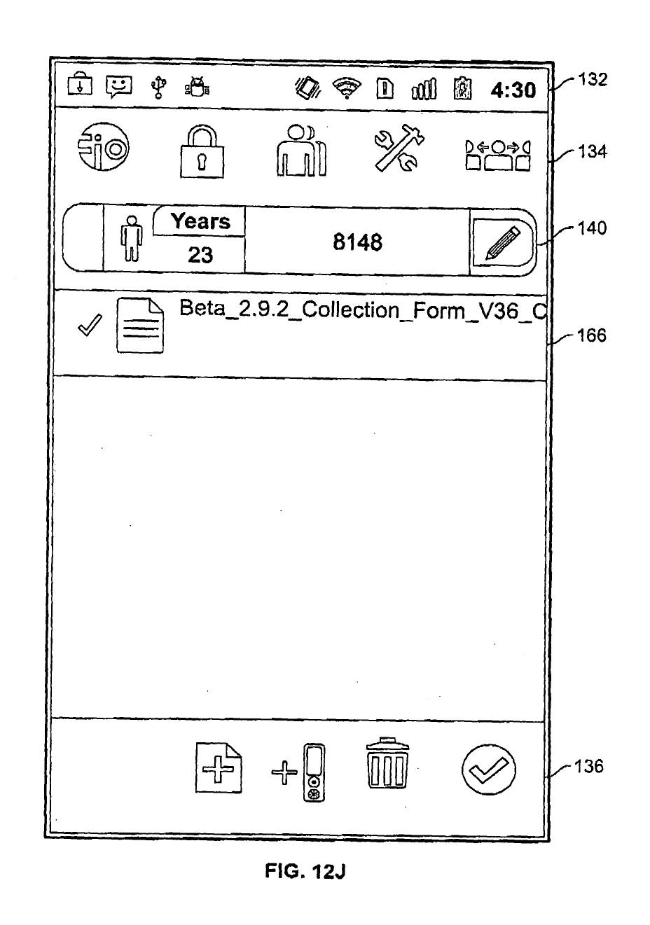

FIGS. 12A through 12J illustrate how “FORMS” functions and menus might be navigated by the user. FIG. 12A shows how a new patient might be added. An add patient window 160 presents the user with requests for patient information, including ID (alternately “identification”) entry 160a, date of birth entry 160b, age entry 160c, and/or gender selection 160d (which may include female pregnancy status). The action window 136 provides the user with an option to confirm the provided information.

FIG. 12B shows a patient home screen (alternately “patient home window”) 161, where forms may preferably be added for the patient. The window 161 may include the patient information window 140. In addition, the action window 136 may provide for various additional options (e.g., confirming the patient selected, deleting the patient selected, adding one or more tests to associate with the patient selected, etc.).

FIG. 12C shows a form selection screen (alternately “form selection window”) 162 of the GUI for another patient. Included with the form selection window 162 may be the patient information window 140.

FIG. 12D shows a dialog window 104 which may preferably be displayed while a form is loading (e.g., malaria evaluation). Accompanying the dialog window 104 may be the patient information window 140 for the selected patient.

FIG. 12E illustrates how it may preferably be possible to delete a form before it is filled out. This is depicted in the dialog window 104, which is also accompanied by the patient information window 140 for the selected patient.

FIG. 12F shows a first (title) screen for another form or a form information window 163 to advise the user of the current form. The patient information window 140 for the selected patient is also preferably provided.

FIG. 12G illustrates how a form might be filled out using a form entry window 164. The action window 136 may preferably provide a virtual keyboard so that the user may input the relevant information (e.g., the manufacturer name for a particular rapid diagnostic test). The patient information window 140 for the selected patient is also preferably provided.

FIG. 12H provides the dialog window 104 for exiting a form which might be presented to the user. In this situation, the user may be provided with various options for exiting the form (e.g., discard changes without saving, etc.). The patient information window 140 for the selected patient is also preferably provided.

FIG. 12I shows a form summary screen (alternately “form summary window”) 165 which might be presented to the user after the form is filled out. This window 165 may include selected information such as, for example: diagnostic test manufacturer, test type, and/or the number of test lines. The patient information window 140 for the selected patient is also preferably provided.

FIG. 12J shows how the patient home screen 161 might appear after the form is filled out. A form list window 166 is provided to show the forms associated with a selected patient depicted in the patient information window 140.

As before, for each of FIGS. 12A to 12J, the status bar 132 and setup window 134 may be provided. In addition, for FIGS. 12C to 12F and 12H to 12J, the action window 136 provides the user with additional options (e.g., to confirm provided information, add additional test information, etc.).

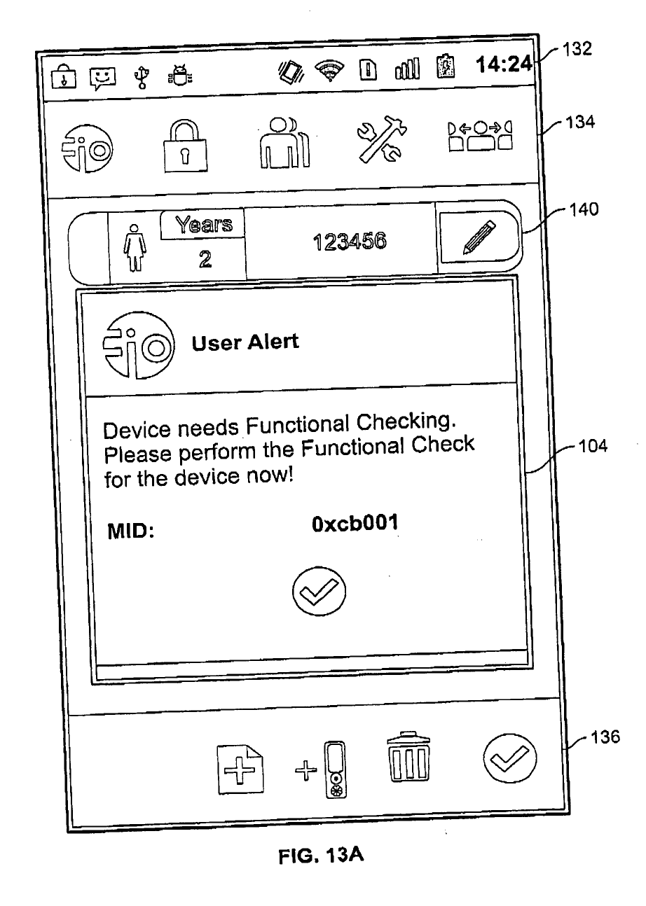

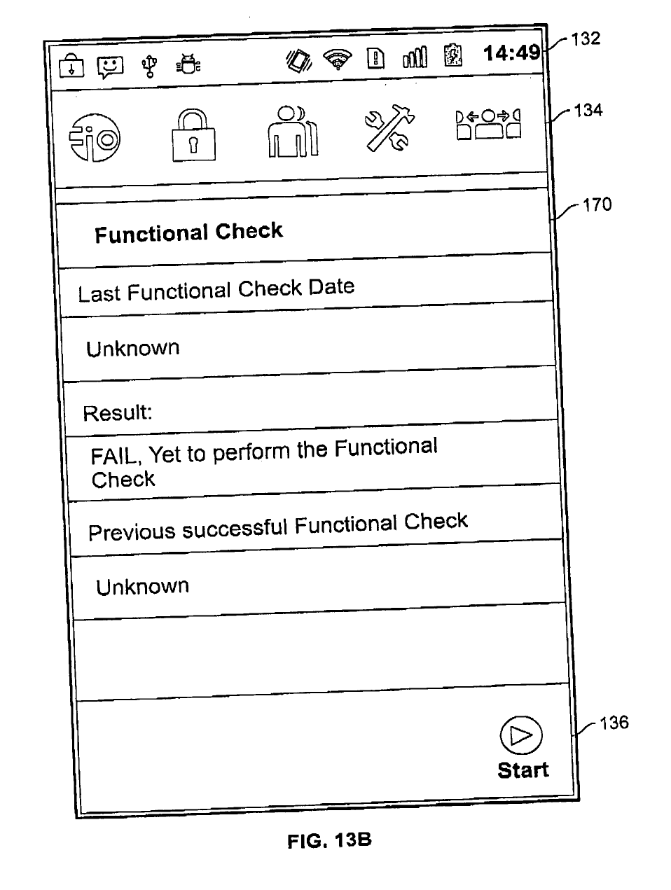

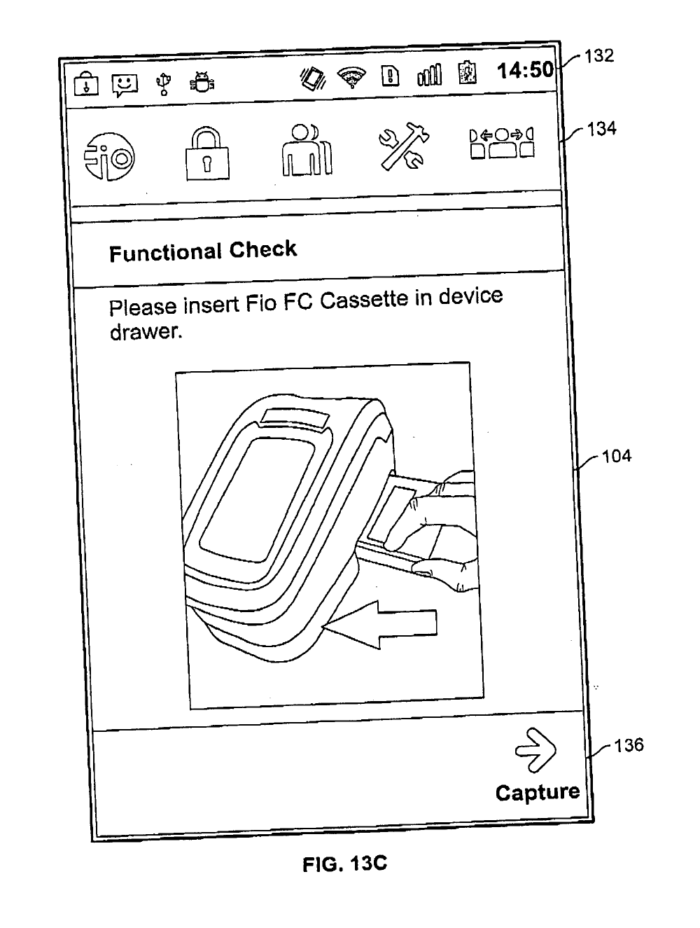

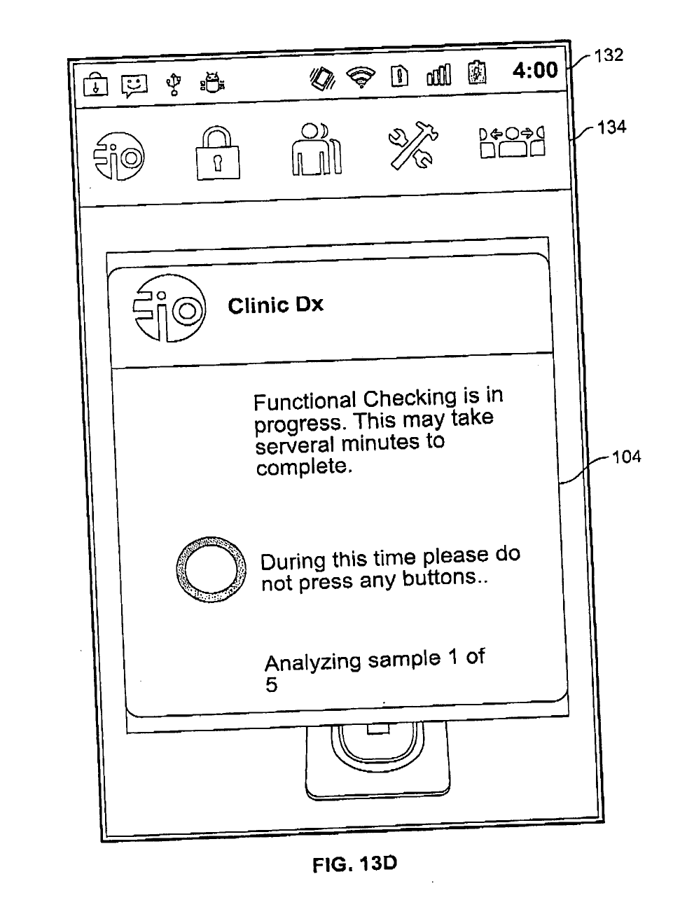

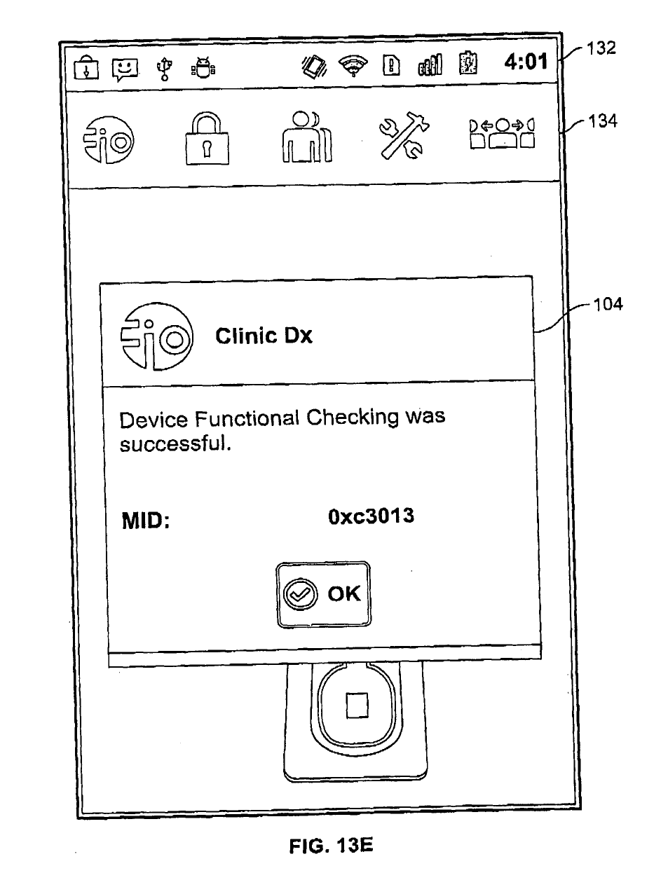

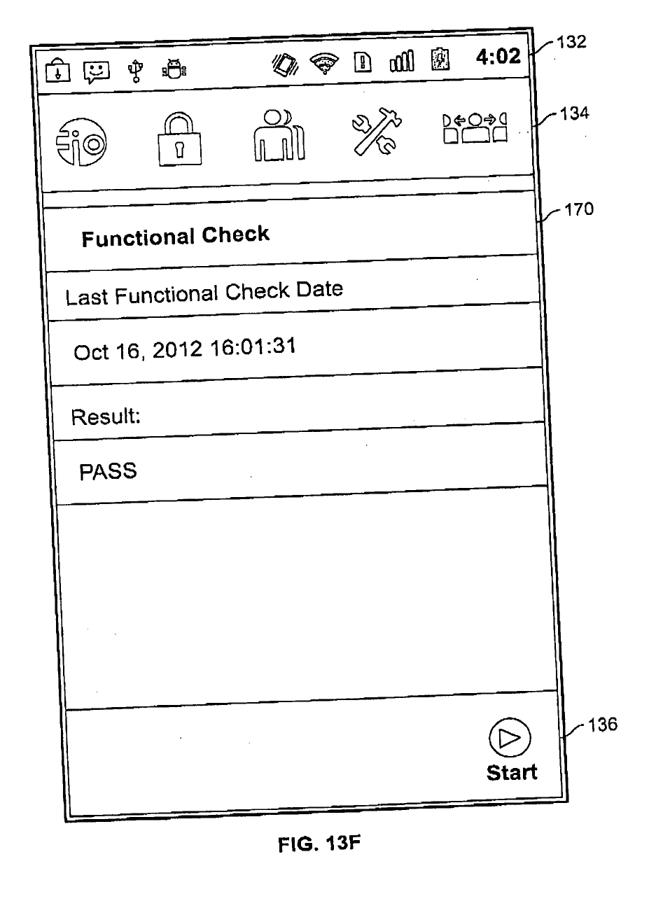

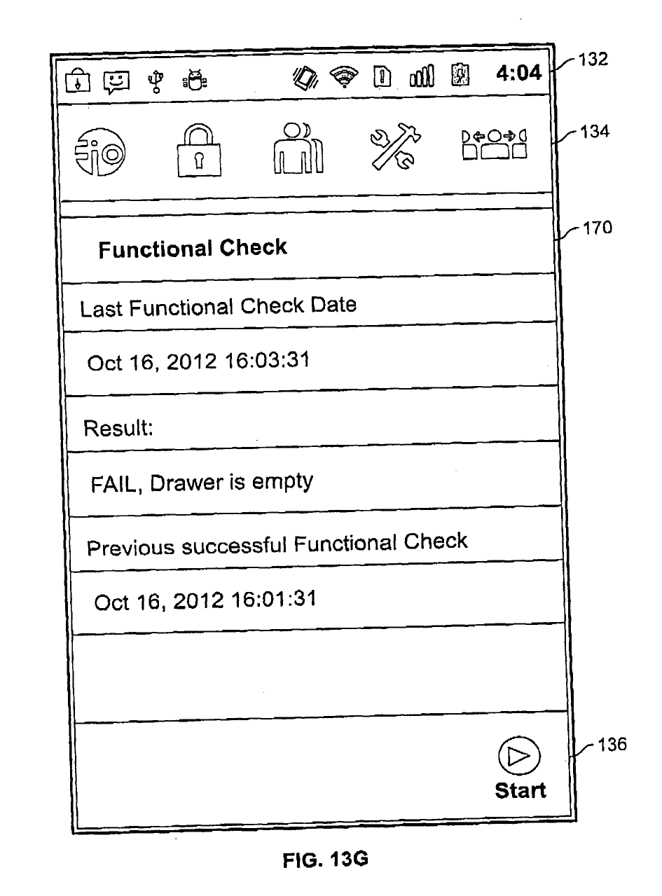

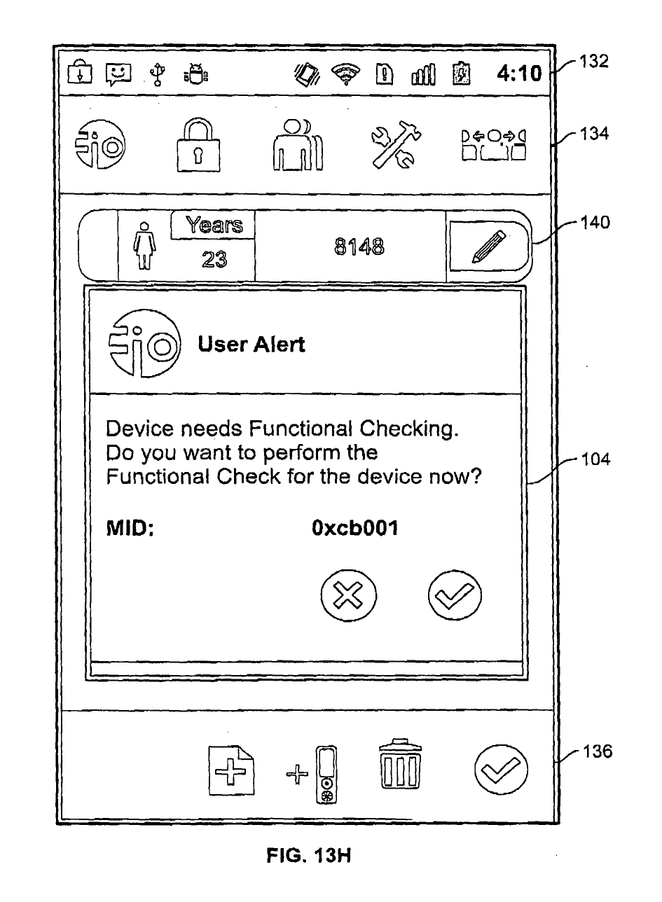

FIGS. 13A through 13H illustrate how “FUNCTIONAL CHECK” (or “FC”) functions and menus might be navigated by the user. FIG. 13A shows the dialog window 104 which may preferably be presented to a user for a mandatory FC, e.g., in the process of adding a test. The patient information window 140 for the selected patient is provided along with the action window 136 containing optional functions.

FIG. 13B shows a FC home screen (alternately “FC home window”) 170 of the GUI, which may provide information such as the last FC date, result, and/or previous successful FC. The action window 136 may also be provided to initiate an FC.

FIG. 13C shows the dialog window 104 with an “insert FC RDT” message which may preferably be presented to the user. The action window 136 may provide for a capture function.

FIG. 13D shows the dialog window 104 with a FC status screen which may preferably be presented to the user during analysis of a captured image (e.g., on the first capture).

FIG. 13E shows a dialog window 104 which may preferably be presented to the user after successful FC completion.

FIG. 13F shows how the FC home window 170 may preferably be presented to the user after passing the FC. The home window 170 may include information such as the last FC date and result. The action window 136 may provide a start option, for example, for another FC.

FIG. 13G shows how the FC home window 170 may be presented after failing the FC. The home window 170 may include information such as the last FC date, result, and/or previous successful FC. The action window 136 may provide a start option, for example, for another FC.

FIG. 13H shows the dialog window 104 with an optional FC message advising of the need for a FC and allowing the user to select whether or not to perform the FC. The patient information window 140 is provided for the selected patient and the action window 136 provides the user with additional options.

FIGS. 13A to 13H each also include the status bar 132 and setup window 134.

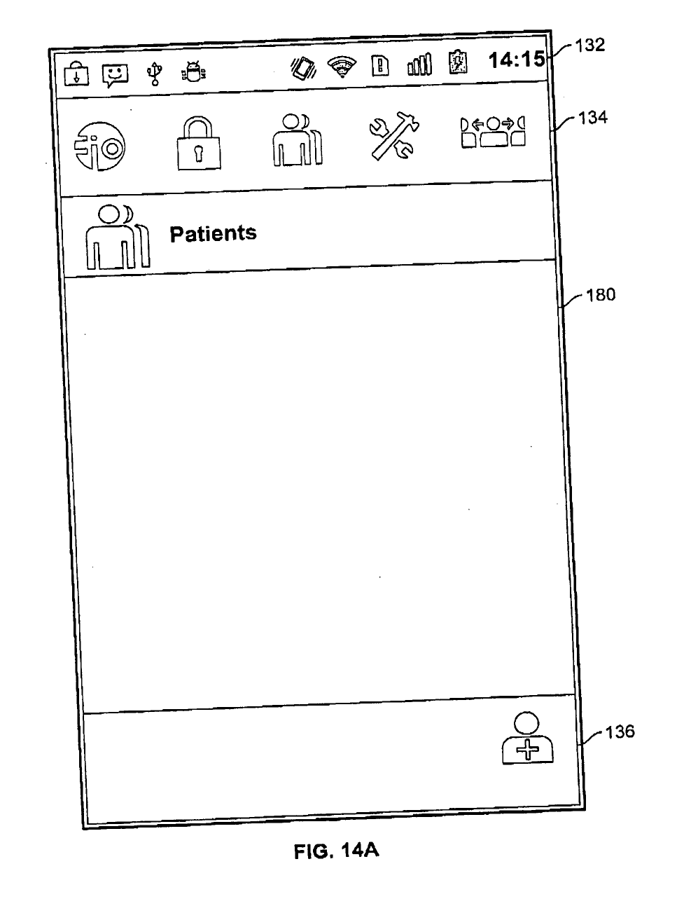

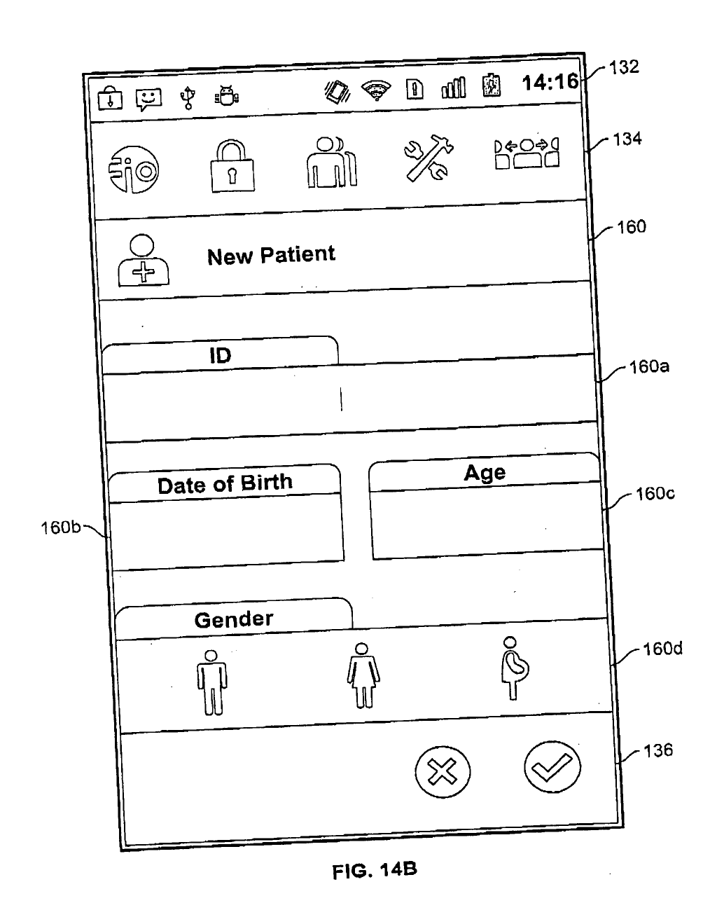

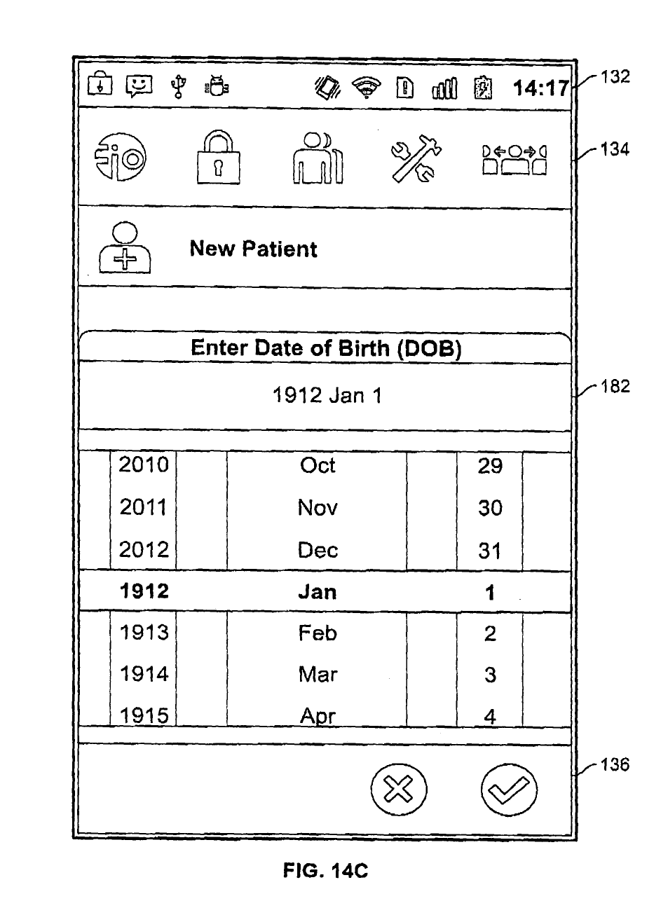

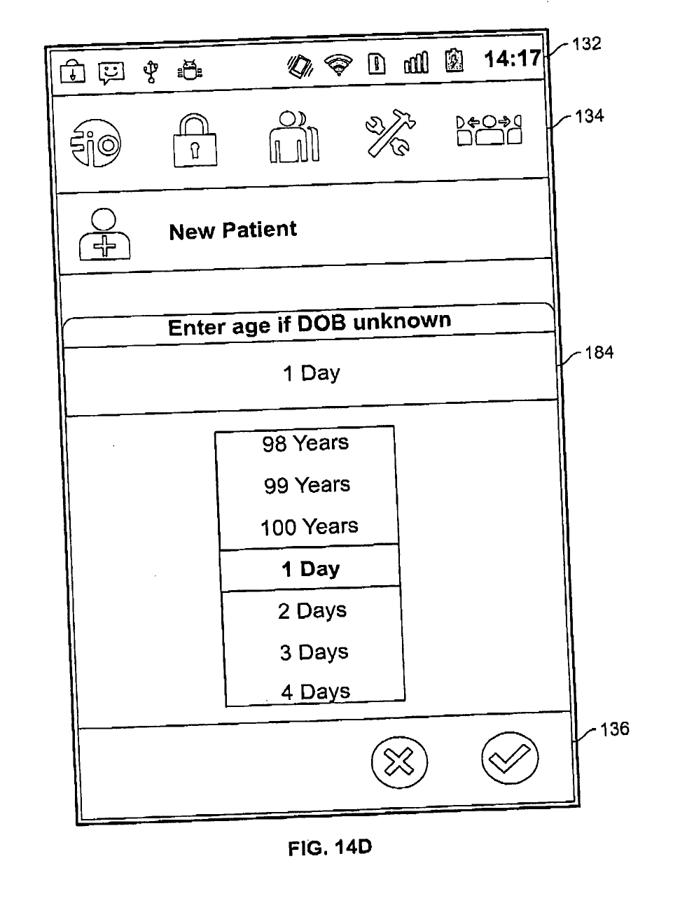

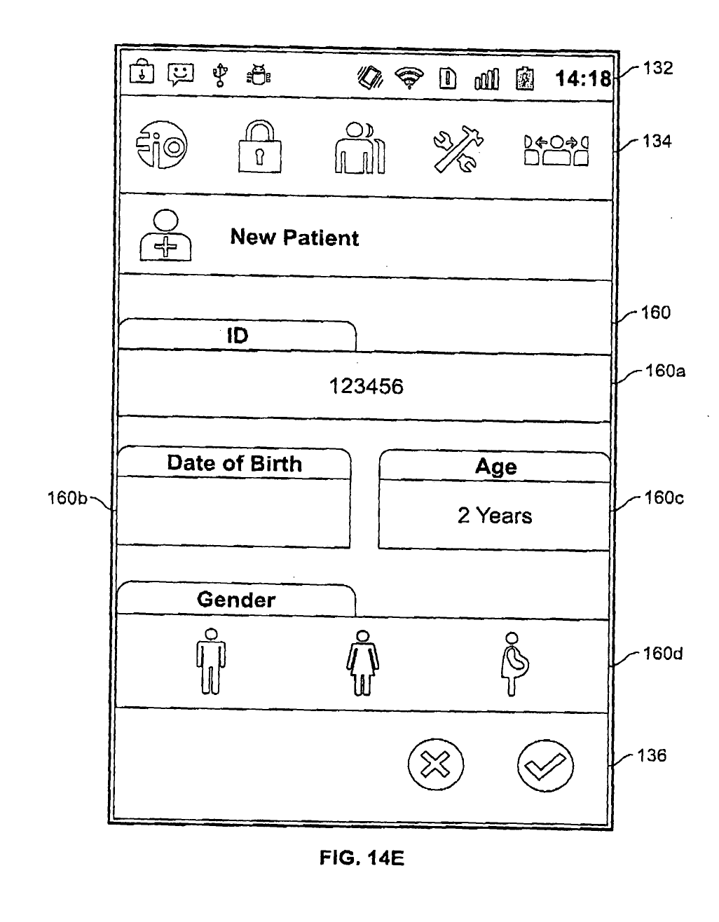

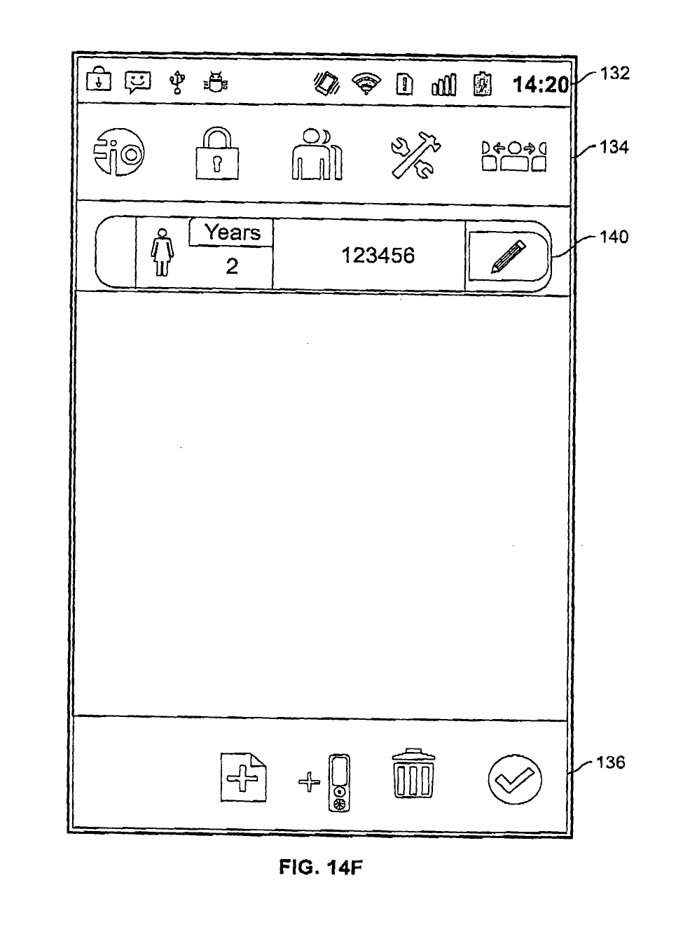

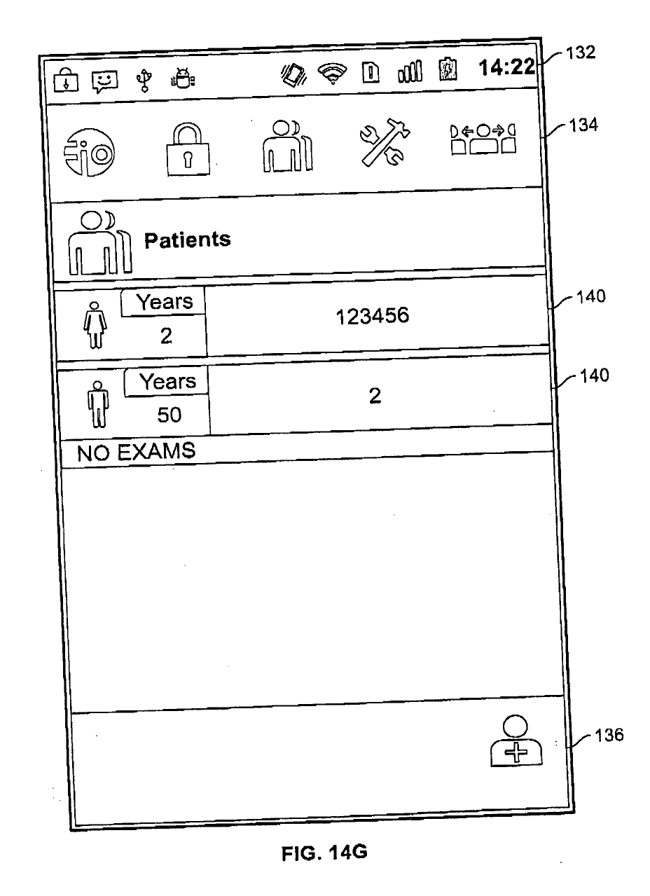

FIGS. 14A through 14G illustrate how “PATIENT INFO” functions and menus might be navigated by the user. For example, FIG. 14A shows how the home screen of an example application (alternately the “application home window) 180 (i.e., the Clinic Dx application) might be presented to the user.

FIG. 14B shows the add patient window 160 of the GUI (including ID entry 160a, date of birth entry 160b, age entry 160c, and/or gender entry 160d).

FIG. 14C shows how a patient's date of birth (“DOB”) might be entered using a date of birth entry window 182.

FIG. 14D shows an alternate method of entering a patient's age which might be used, e.g., if DOB is unknown, using an age entry window 184.

FIG. 14E shows how the add patient window 160 might appear after patient information details have been filled out.

FIG. 14F shows how an entered patient's home screen might appear (e.g., without any tests or forms completed) and includes, among others, the patient information window 140 for the selected patient.

FIG. 14G shows how the patient manager window 144 might be presented, and includes a patient information window 140 for two listed patients.

For each of FIGS. 14A to 14G, the status bar 132, setup window 134 and action window 136 are also provided.

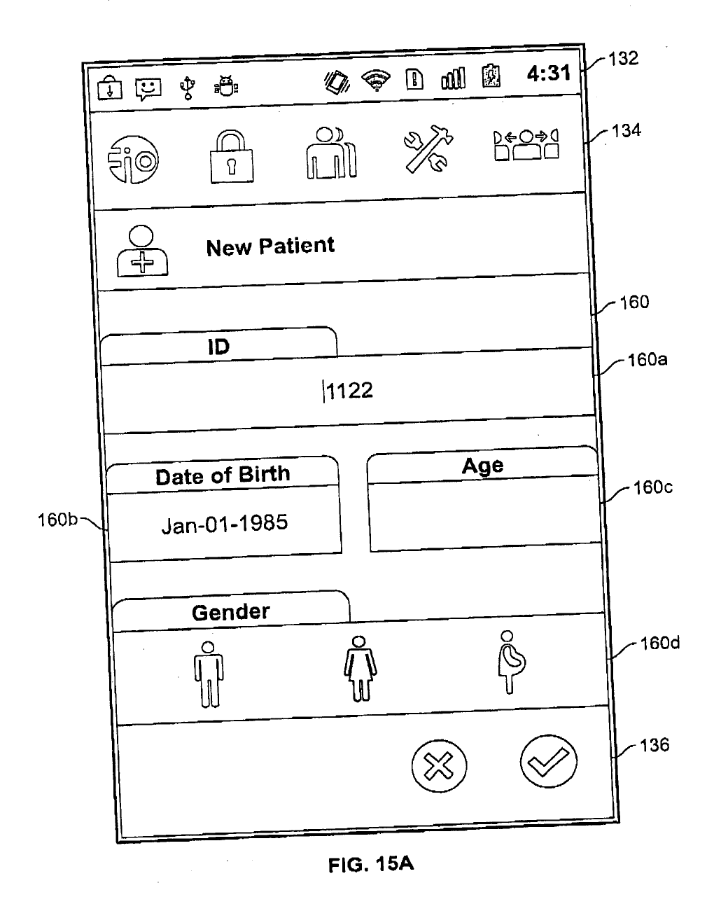

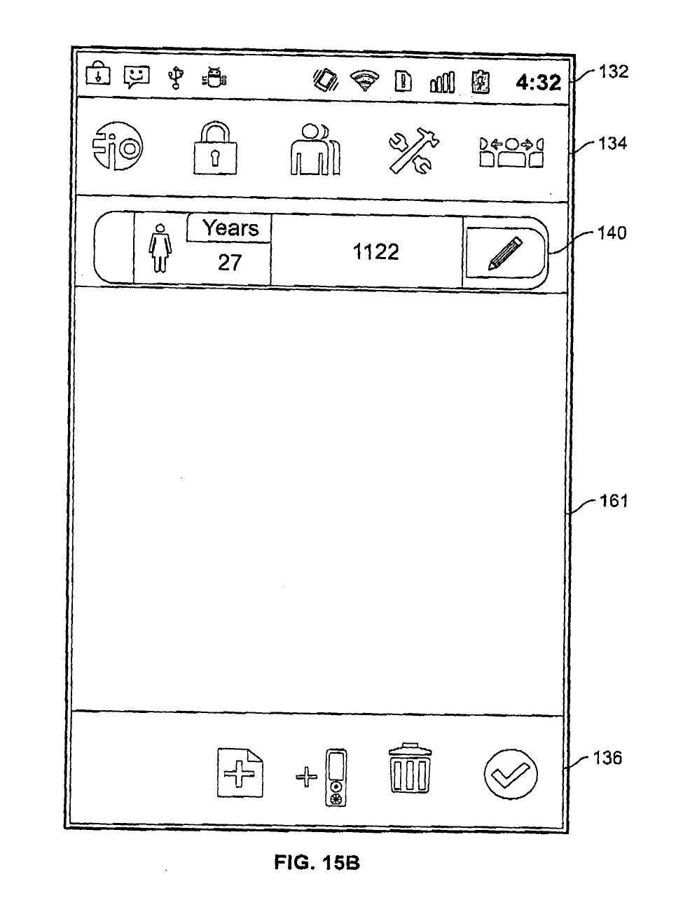

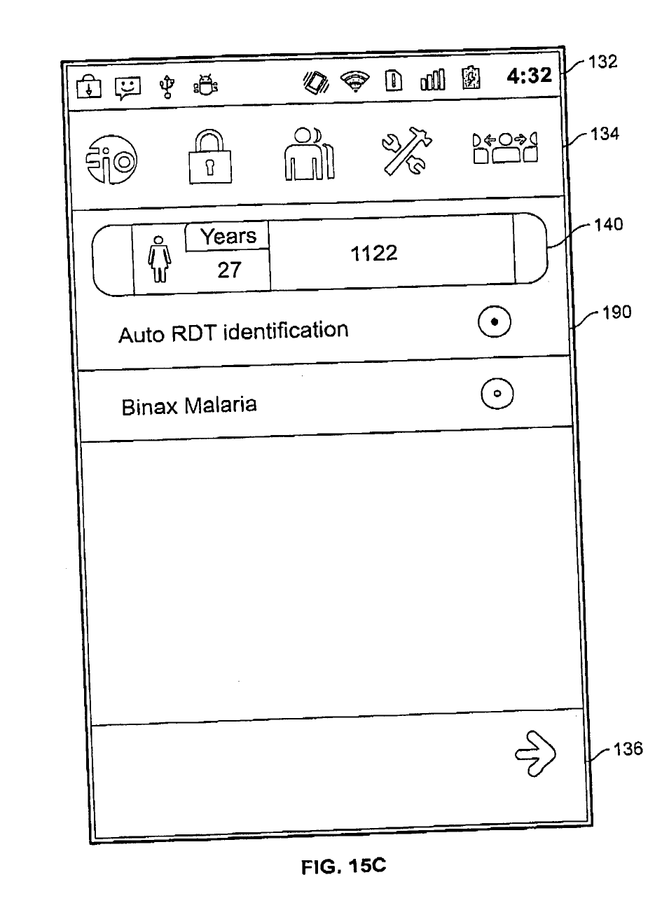

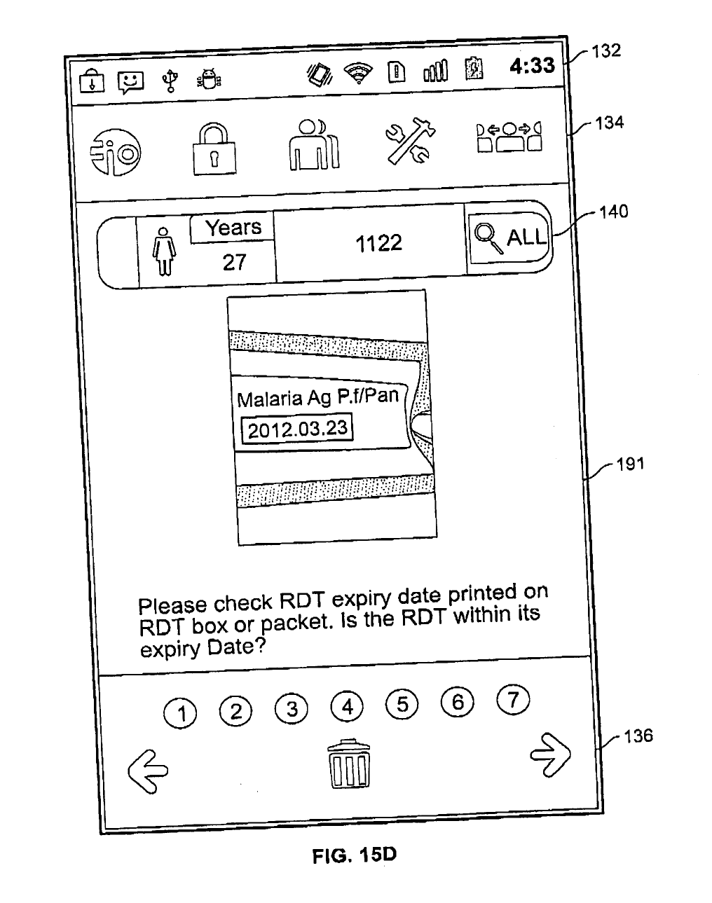

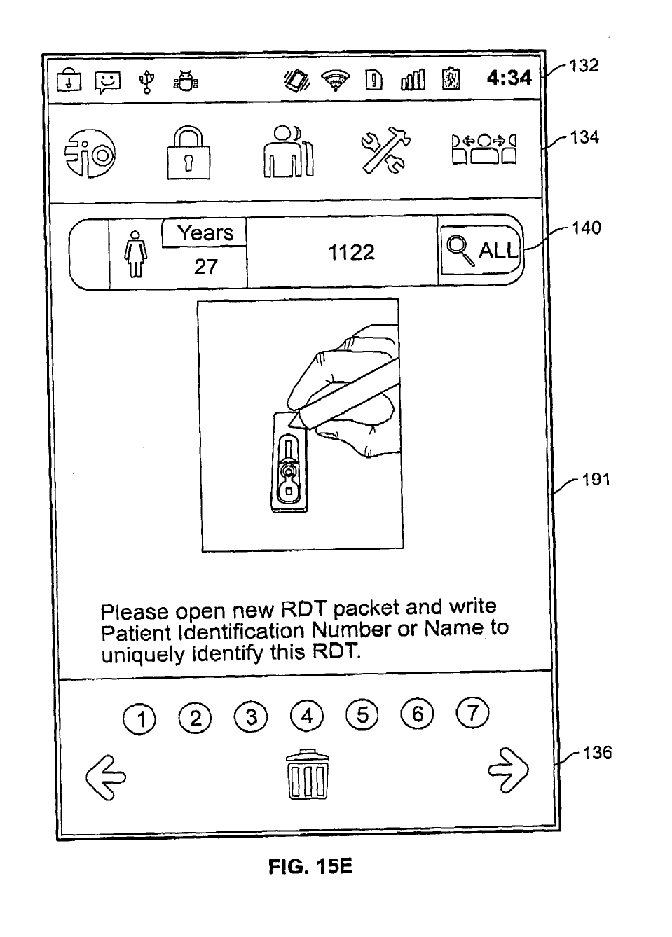

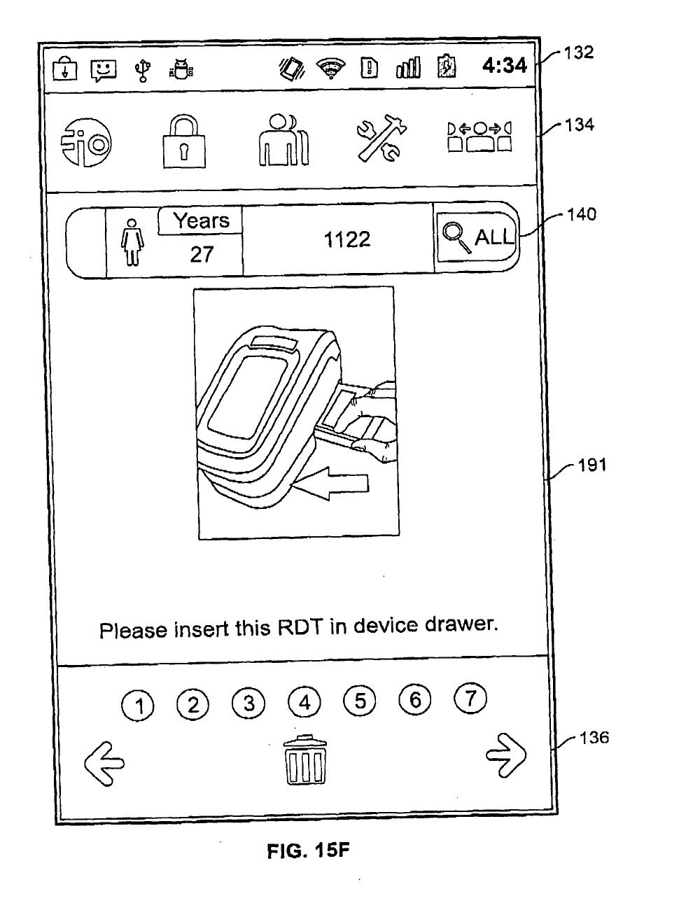

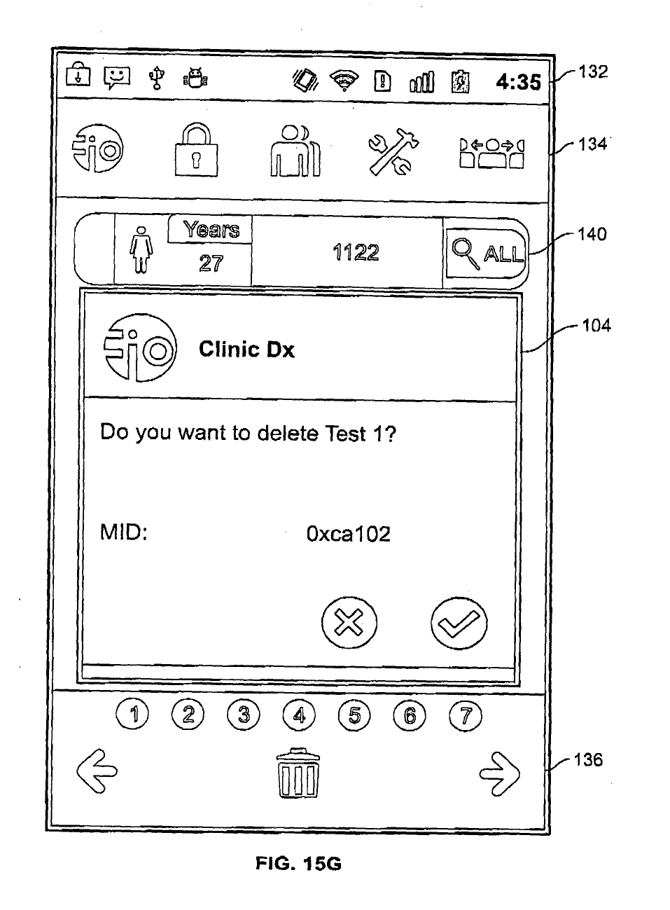

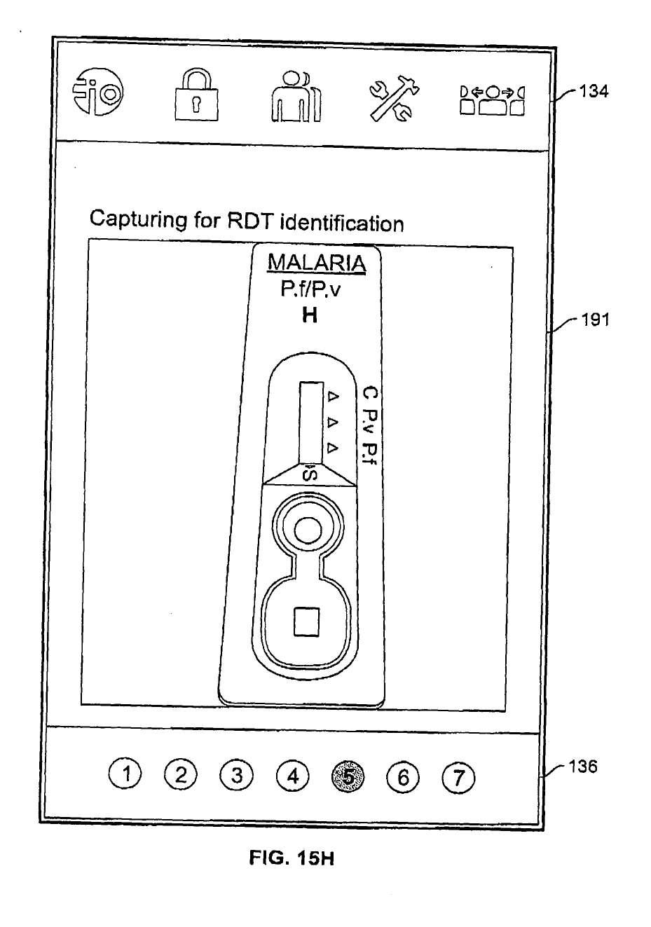

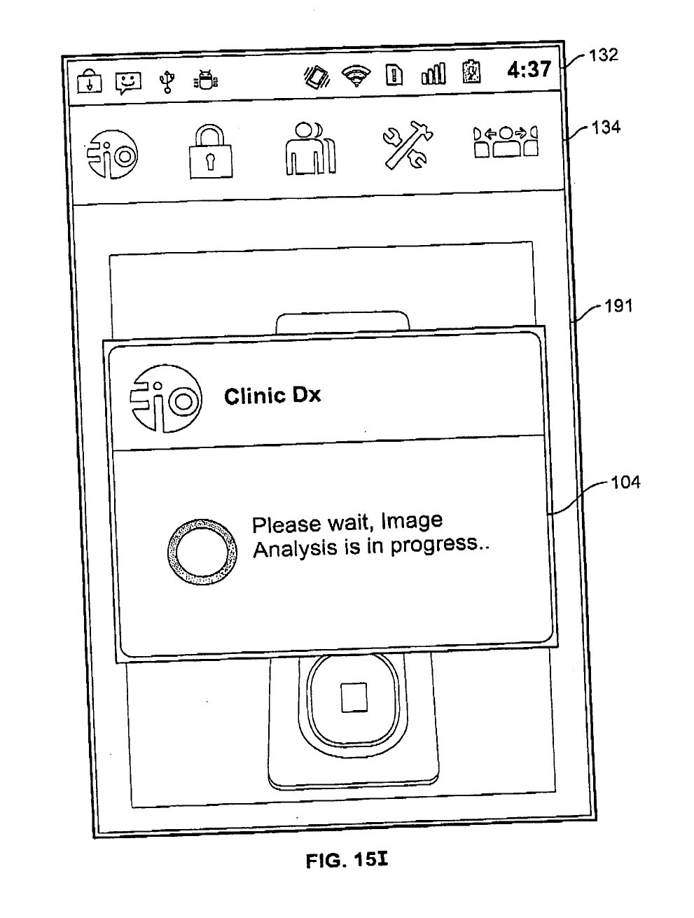

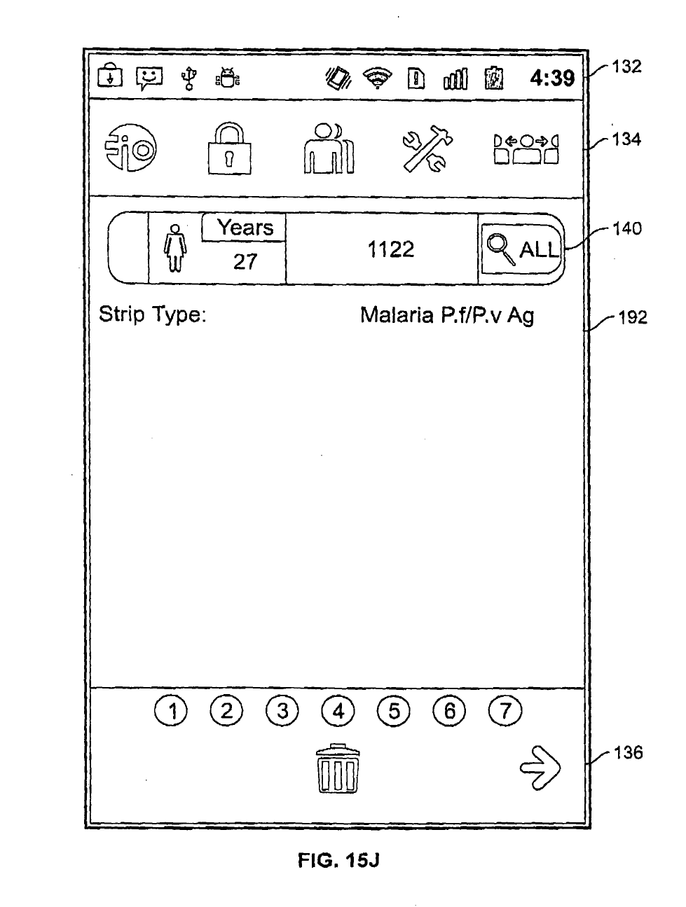

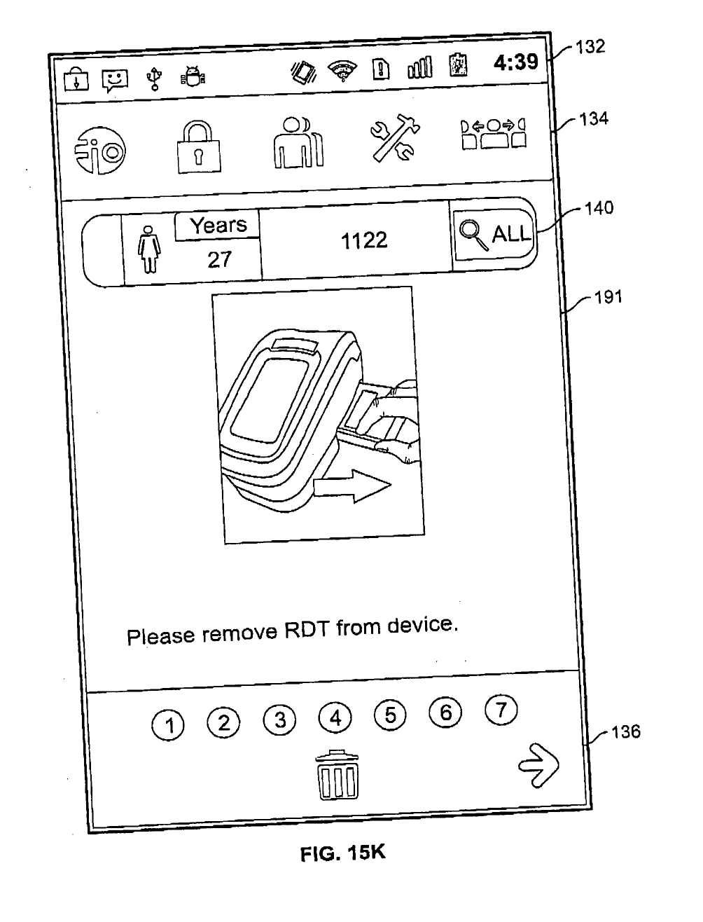

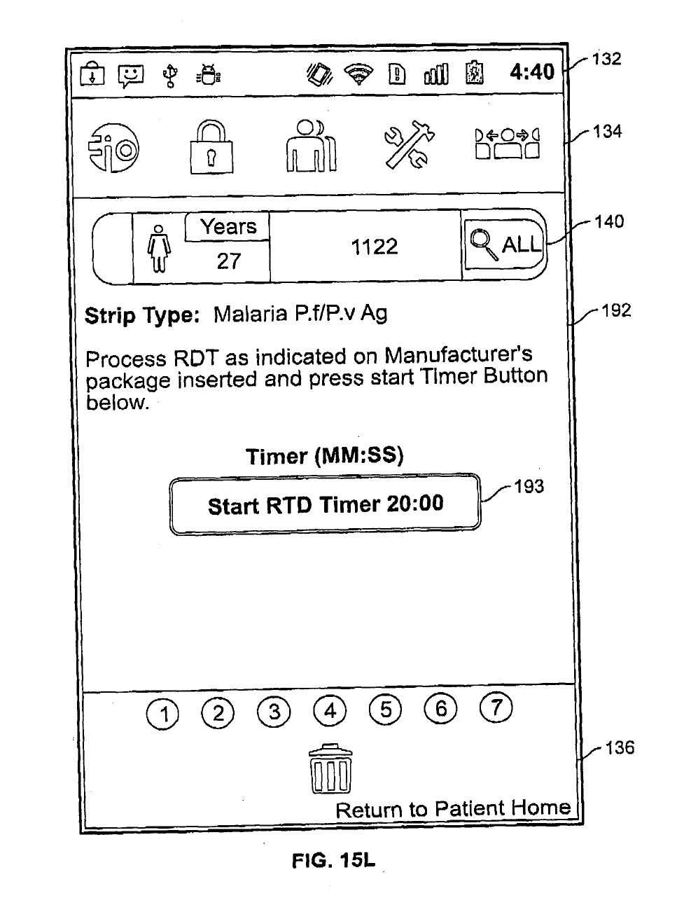

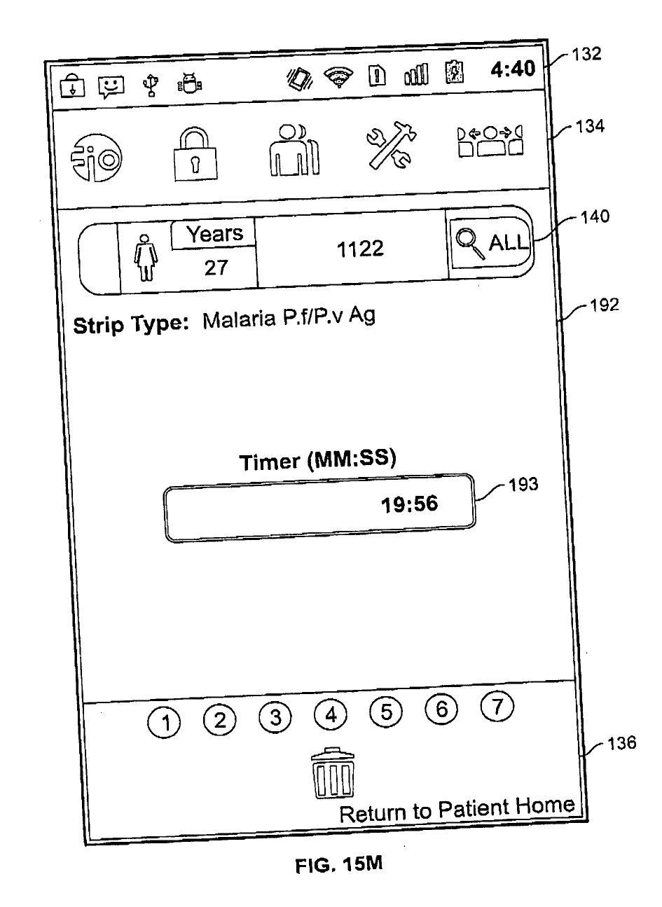

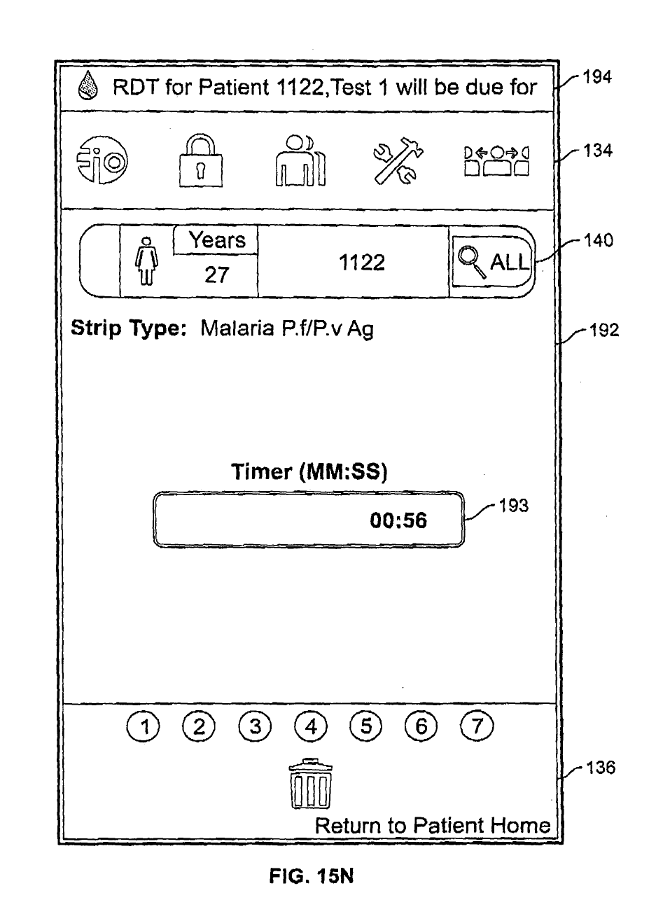

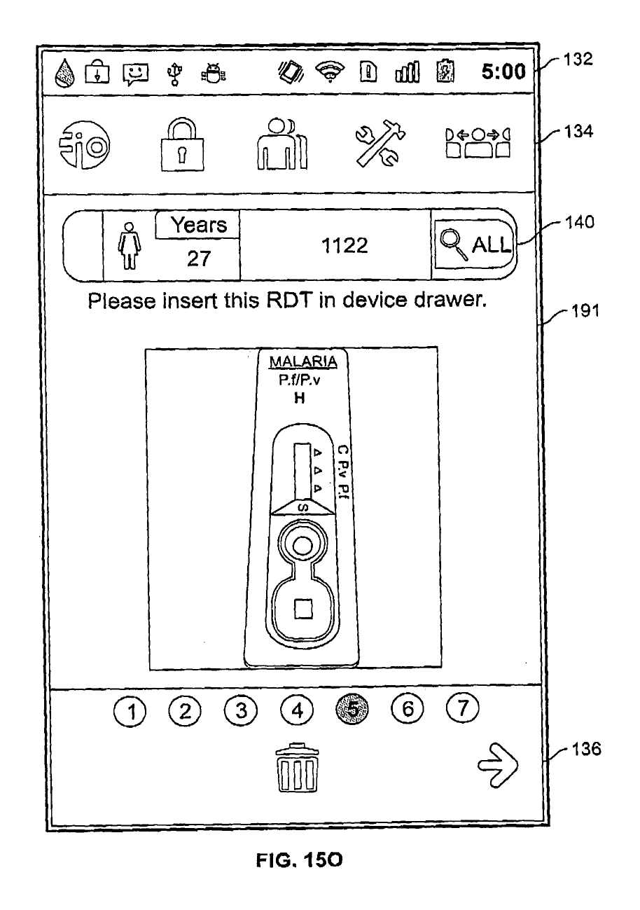

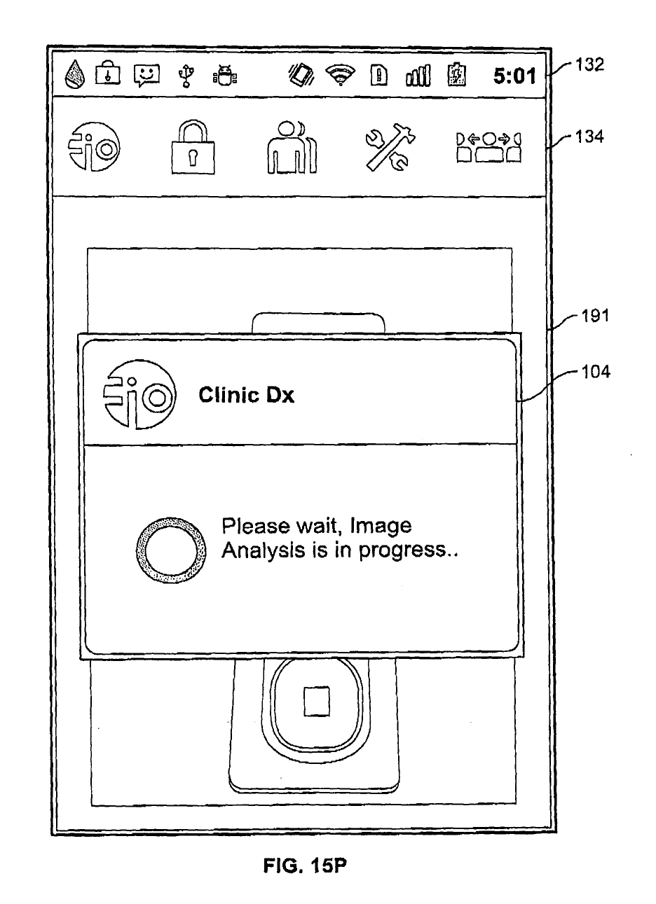

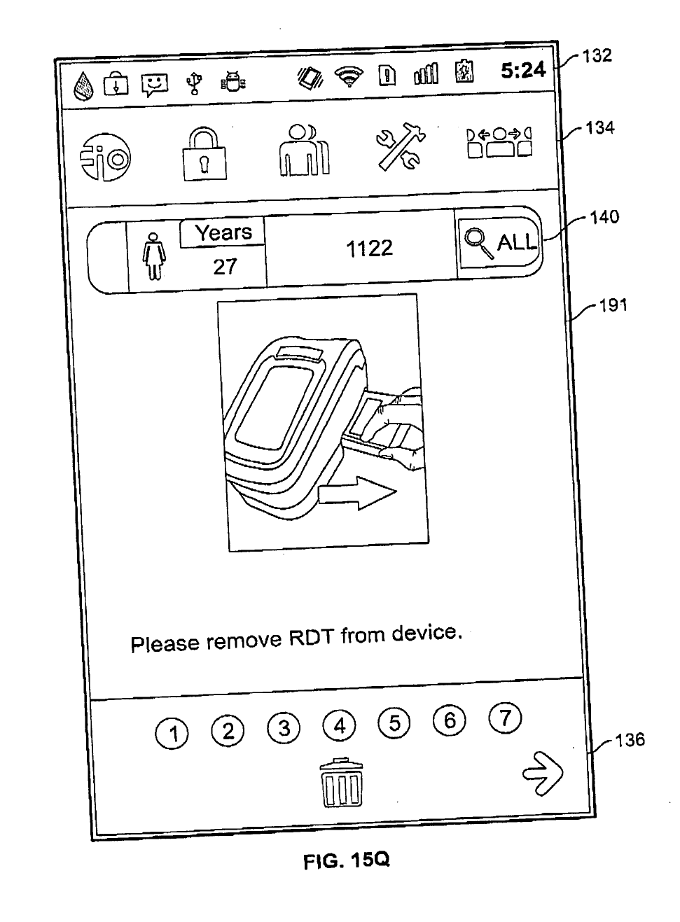

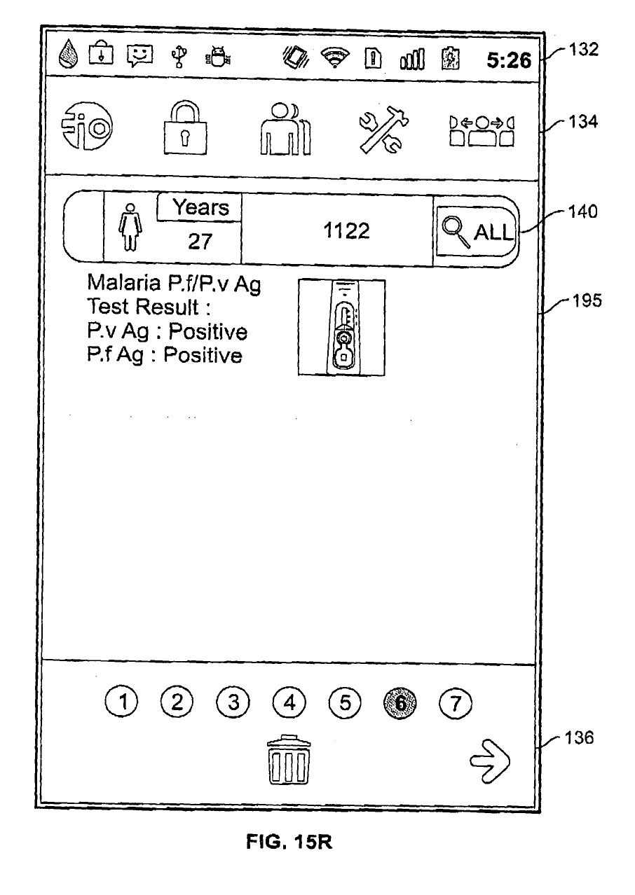

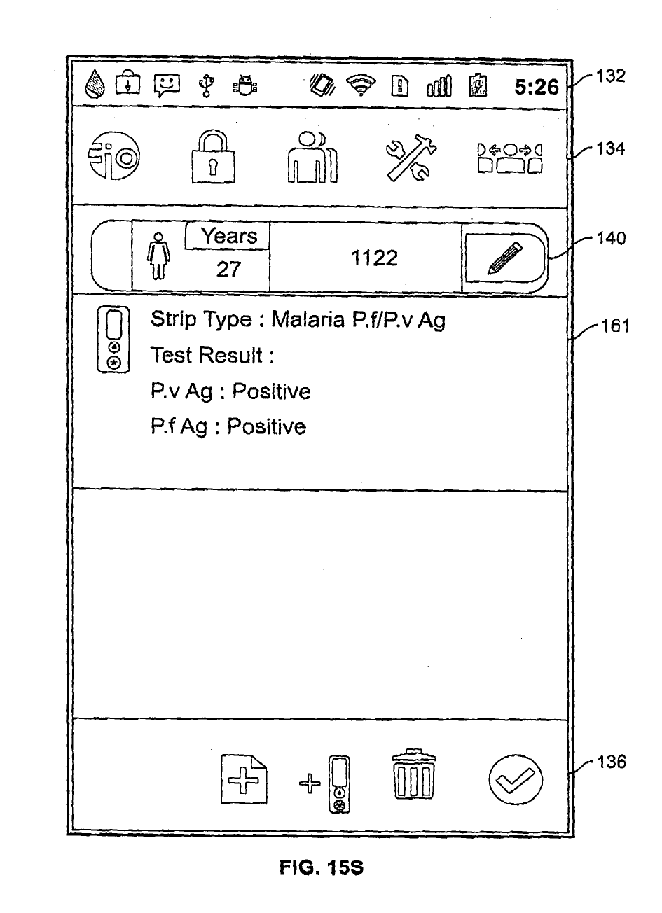

FIGS. 15A through 15S illustrate how “TEST” functions and menus might be navigated by the user. FIG. 15A shows how a patient might be added using the add patient window 160 (including details for each of the ID entry 160a, date of birth entry 160b, age entry 160c, and/or gender entry 160d).

FIG. 15B shows how the patient home window 161 might appear and includes the patient information window 140 for the selected patient.

FIG. 15C shows how a rapid diagnostic test (or “RDT”) might be selected and/or identified using the RDT selection window 190 (e.g., auto RDT identification, binax malaria). The selection window 190 may also include the patient information window 140 for the selected patient.

FIG. 15D shows a guide screen (alternately “RDT guide window”) 191 which may instruct the user to check the RDT's expiry date. The patient information window 140 for the selected patient may also be provided.

FIG. 15E shows the RDT guide window 191 instructing the user to write a Patient ID on the RDT. The patient information window 140 for the selected patient may also be provided.

FIG. 15F shows the RDT guide window 140 instructing the user to insert the RDT in a device drawer. The patient information window 140 for the selected patient may also be provided.

FIG. 15G shows the dialog window 104 with a prompt for the user on whether to delete the test. The patient information window 140 for the selected patient may also be provided.

FIG. 15H shows the RDT guide window 140 during RDT capture for strip identification (e.g., malaria).

FIG. 15I shows the dialog screen 104, overlayed against the RDT guide window 191, presenting a message during analysis of a captured image.

FIG. 15J shows how a strip identification may be presented on a results screen (alternately “results window”) 192 of the GUI. The patient information window 140 for the selected patient may also be provided.

FIG. 15K shows the RDT guide window 191 instructing the user to remove the RDT after strip identification. The patient information window 140 for the selected patient may also be provided.

FIG. 15L shows a start timer screen (alternately “timer window”) 193 of the GUI along with the results window 192 (which may optionally display a message to the user for processing the diagnostic test) and the patient information window 140 for the selected patient.

FIG. 15M shows how the GUI may appear during incubation time as shown by the timer window 193. Also appearing on the GUI are the results window 192 and the patient information window 140.

FIG. 15N shows a status bar notification (alternately “notification window”) 194 which may be presented on the GUI less than one (1) minute before timer expiry as depicted by the timer window 193. Also appearing on the GUI are the results window 192 and the patient information window 140.

FIG. 15O shows the RDT guide window 191 instructing the user to insert the RAT for image analysis. The patient information window 140 for the selected patient may also be provided.

FIG. 15P shows the dialog window 104 which may be presented during image analysis overlayed against the RDT guide window 191.

FIG. 15Q shows the RDT guide window 191 instructing the user to remove the RDT after image analysis. The patient information window 140 for the selected patient may also be provided.

FIG. 15R shows a test results screen (alternately “test results window”) 195 (e.g., for malaria). The patient information window 140 for the selected patient may also be provided.

FIG. 15S shows how the patient home window 161 for a given patient (as shown in the patient information window 140) may be presented on the GUI after finishing a test process.

Each of FIGS. 15A through 15S may include the status bar 132, setup window 134 and/or action window 136. In some screens (e.g., FIGS. 15D to 15G, 15J to 15O, 15Q and 15R), the action window 136 may include a series of numbers—for example, from 1 to 7—which may be used to provide the user with an indication of the current step in the RDT analysis process.

Naturally, in view of the teachings and disclosures herein, persons having ordinary skill in the art may appreciate that alternate designs and/or embodiments of the invention may be possible (e.g., [symbol] components for others with alternate configurations of components, etc). Among other things, it should be appreciated that, although some of the components, relations, and/or configurations of the systems, methods and component readable media according to the invention are not specifically referenced in association with one another, they may be used, and/or adapted for use, in association therewith.

The system, method and/or computer readable medium according to the invention are contemplated for use by health professionals around the world, in association with devices, to provide patient services at, near or remote from the point of care. The invention, however, is not so limited. Other modifications and alterations may be used in the design, manufacture, and/or implementation of other embodiments according to the present invention without departing from the spirit and scone of the invention, which is limited only by the claims of any regular patent applications claiming priority herefrom.

It should be appreciated that, although some of the components, relations, configurations and/or steps of the devices, systems, methods and computer readable media according to the invention are not specifically referenced in association with one another, they may be used, and/or adapted for use, in association therewith.

All of the aforementioned, depicted and various structures, configurations, relationships, utilities and the like may be, but are not necessarily, incorporated into and/or achieved by the invention. Any one or more of the aforementioned structures, configurations, relationships, utilities and the like may be implemented in and/or by the invention, on their own, and/or without reference, regard or likewise implementation of any of the other aforementioned structures, configurations, relationships, utilities and the like, in various permutations and combinations, as will be readily apparent to those skilled in the art, without departing from the pith, marrow, and spirit of the disclosed invention.

Other modifications and alterations may be used in the design, manufacture, and/or implementation of other embodiments according to the present invention without departing from the spirit and scope of the invention, which is limited only by the claims of any regular patent applications claiming priority herefrom.

This concludes the description of presently preferred embodiments of the invention. The foregoing description has been presented for the purpose of illustration and is not intended to be exhaustive of to limit the invention to the precise form disclosed. Other modifications, variations and alterations are possible in light of the above teaching and will be apparent to those skilled in the art, and may be used in the design and manufacture of other embodiments according to the present invention without departing from the spirit and scope of the invention. It is intended the scope of the invention be limited not by this description but only by the claims forming a part hereof.

1. A launcher system for use, in health-related fields, by a user of an executable software application and an electronic device having an operating system, wherein the launcher system comprises:
(a) one or more databases comprising one or more applicable health standards and protocols, wherein the health standards and protocols govern proper use of health data, operation and quality control of the electronic device, the operating system, and the software application in the health-related fields;
(b) an application programming interface (API) sub-layer which communicates with the software application;
(c) an interfacing sub-layer which communicates with the operating system and/or the electronic device; and
(d) a logic sub-layer which automatically: (i) receives the health standards and protocols from the databases; (ii) mediates communication between the API sub-layer and the interfacing sub-layer; and (iii) ensures the use of health data, the operation and the quality control of the software application, the operating system and the electronic device are in compliance with all of the applicable health standards and protocols.

2. The launcher system according to claim 1, further comprising a graphical user interface which is presented to the user following startup of the electronic device, and which mediates interactions of the user with the software application, the operating system and the electronic device.

3. The launcher system according to claim 1, wherein the health standards and protocols comprise privacy and security standards and protocols which govern proper privacy and security of health data, the software application, the operating system, and the electronic device in the health-related fields.

4. The launcher system according to claim 1, wherein one or more of the health standards and protocols are selected from the group consisting of: the United States' Health Insurance Portability and Accountability Act (HIPAA) standard; the Health Level Seven (HL7) framework and standards; the Hypertext Transfer Protocol Secure (HTTPS) communications protocol; the Point-of-Care Connectivity (POCT1) standard; and the Digital Imaging and Communications in Medicine (DICOM) standard.

5. The launcher system according to claim 1, wherein the health standards and protocols comprise in vitro diagnostic protocols which govern proper in vitro diagnostic methodologies for the software application, the operating system, and the electronic device.

6. The launcher system according to claim 1, wherein the health standards and protocols are jurisdictionally specific.

7. The launcher system according to claim 6, wherein the logic sub-layer automatically receives the health standards and protocols depending on a jurisdiction in which the electronic device is located.

8. The launcher system according to claim 1, wherein the databases are located remotely from the electronic device.

9. The launcher system according to claim 1, wherein the databases store patient results comprising patient identifying information, and wherein the logic sub-layer restricts access to the patient results other than by the user who collected the patient results.

10. The launcher system according to claim 1, wherein the logic sub-layer anonymizes any patient results which are output from the software application to remove any patient identifying information.

11. The launcher system according to claim 1, wherein the databases anonymously store one or more aggregate results absent any patient identifying information, and wherein the logic sub-layer permits the software applications to store and/or access the aggregate results.

12. The launcher system according to claim 1, wherein the databases store the software application, and wherein the launcher system retrieves the software application from the databases for execution by the electronic device.

13. The launcher system according to claim 1, wherein the databases store one or more launcher operating system versions, each adapted to encode the interfacing sub-layer to function with at least one said operating system, agnostic of any intended execution of the software application in association with any said operating system; and wherein the interfacing sub-layer automatically receives, depending on the operating system of the electronic device, one of the launcher operating system versions to automatically encode the interfacing sub-layer to function with the operating system of the electronic device.

14. The launcher system according to claim 1, wherein the databases store one or more launcher operating system versions, each adapted to encode the API sub-layer to execute the software application in view of an intended execution of the software application with one said operating system, agnostic of the operating system of the electronic device; and wherein the API sub-layer automatically receives, depending on the intended execution of the software application with one said operating system, one of the launcher operating system versions to automatically encode the API sub-layer to execute the software application.

15. The launcher system according to claim 1, wherein the databases store one or more launcher operating system versions, each adapted to encode the interfacing sub-layer to function with a first one said operating system and encode the API sub-layer to execute the software application in view of an intended execution of the software application with a second one said operating system different than the first one; wherein the interfacing sub-layer and the API sub-layer automatically receive, depending on the first one and the second one said operating system, one of the launcher operating system versions to automatically encode the interfacing sub-layer to function with the operating system of the electronic device, and to automatically encode the API sub-layer to execute the software application.

16. The launcher system according to claim 1, wherein the interfacing sub-layer communicates directly with the electronic device, free of the operating system, when appropriate in view of the health standards and protocols.

17. The launcher system according to claim 1, wherein the API sub-layer and the interfacing sub-layer communicate directly with each other, free of mediation by the logic sub-layer, when appropriate in view of the health standards and protocols.

18. The launcher system according to claim 1, wherein the interfacing sub-layer disables access of the software application to any location services and/or camera functionalities otherwise afforded by the electronic device.

19. The launcher system according to claim 1, wherein, in mediating communication between the API sub-layer and the interfacing sub-layer and in ensuring compliance with all of the applicable health standards and protocols, the logic sub-layer automatically restricts and/or modifies one or more functions of, and communication between, the software application, the operating system and the electronic device.

20. The launcher system according to claim 1, adapted for use with a mobile device or a stationary device as the electronic device.

21. A method for use, in health-related fields, by a user of an executable software application and an electronic device having an operating system, wherein the method comprises the steps of:
(a) using one or more databases for storage of one or more applicable health standards and protocols, wherein the health standards and protocols govern proper use of health data, operation and quality control of the electronic device, the operating system, and the software application in the health-related fields;
(b) using an application programming interface (API) sub-layer to communicate with the software application;
(c) using an interfacing sub-layer to communicate with the operating system and/or the electronic device; and
(d) using a logic sub-layer to automatically: (i) receive the health standards and protocols from the databases; (ii) mediate communication between the API sub-layer and the interfacing sub-layer; and (iii) ensure the use of health data, the operation and the quality control of the software application, the operating system and the electronic device are in compliance with all of the applicable health standards and protocols.

22. The method according to claim 21, further comprising the step of presenting a graphical user interface to the user following startup of the electronic device, and using the graphical user interface to mediate interactions of the user with the software application, the operating system and the electronic device.

23. The method according to claim 21, wherein, in steps (a) and (d), the health standards and protocols comprise privacy and security standards and protocols which govern proper privacy and security of health data, the software application, the operating system, and the electronic device in the health-related fields.

24. The method according to claim 21, wherein, in steps (a) and (d), one or more of the health standards and protocols are selected from the group consisting of: the United States' Health Insurance Portability and Accountability Act (HIPAA) standard; the Health Level Seven (HL7) framework and standards; the Hypertext Transfer Protocol Secure (HTTPS) communications protocol; the Point-of-Care Connectivity (POCT1) standard; and the Digital Imaging and Communications in Medicine (DICOM) standard.

25. The method according to claim 21, wherein, in steps (a) and (d), the health standards and protocols comprise in vitro diagnostic protocols which govern proper in vitro diagnostic methodologies for the software application, the operating system, and the electronic device.

26. The method according to claim 21, wherein, in steps (a) and (d), the health standards and protocols are jurisdictionally specific.

27. The method according to claim 26, wherein, in step (d), the logic sub-layer automatically receives the health standards and protocols depending on a jurisdiction in which the electronic device is located.

28. The method according to claim 21, wherein, in step (a), the databases are located remotely from the electronic device.

29. The method according to claim 21, wherein, in step (a), the databases are also used to store patient results comprising patient identifying information; and wherein, in step (d), the logic sub-layer restricts access to the patient results other than by the user who collected the patient results.

30. The method according to claim 21, wherein, in step (d), the logic sub-layer anonymizes any patient results which are output from the software application to remove any patient identifying information.

31. The method according to claim 21, wherein, in step (a), the databases are also used to anonymously store one or more aggregate results absent any patient identifying information; and wherein, in step (d), the logic sub-layer permits the software applications to store and/or access the aggregate results.

32. The method according to claim 21, wherein, in step (a), the databases are also used to store the software application; and further comprising the step of retrieving the software application from the databases for execution.

33. The method according to claim 21, wherein, in step (a), the databases are also used to store one or more launcher operating system versions, each adapted to encode the interfacing sub-layer to function with at least one said operating system, agnostic of any intended execution of the software application in association with any said operating system; and further comprising the step, before step (c), wherein the interfacing sub-layer automatically receives, depending on the operating system of the electronic device, one of the launcher operating system versions to automatically encode the interfacing sub-layer to function with the operating system of the electronic device.

34. The method according to claim 21, wherein, in step (a), the databases are also used to store one or more launcher operating system versions, each adapted to encode the API sub-layer to execute the software application in view of an intended execution of the software application with one said operating system, agnostic of the operating system of the electronic device; and further comprising the step, before step (b), wherein the API sub-layer automatically receives, depending on the intended execution of the software application with one said operating system, one of the launcher operating system versions to automatically encode the API sub-layer to execute the software application.

35. The method according to claim 21, wherein, in step (a), the databases are also used to store one or more launcher operating system versions, each adapted to encode the interfacing sub-layer to function with a first one said operating system and to encode the API sub-layer to execute the software application in view of an intended execution of the software application with a second one said operating system different than the first one; and further comprising the step, before steps (b) and (c), wherein the interfacing sub-layer and the API sub-layer automatically receive, depending on the first one and the second one said operating system, one of the launcher operating system versions to automatically encode the interfacing sub-layer to function with the operating system of the electronic device, and to automatically encode the API sub-layer to execute the software application.

36. The method according to claim 21, wherein, in step (c) and after step (d), the interfacing sub-layer communicates directly with the electronic device, free of the operating system, when appropriate in view of the health standards and protocols.

37. The method according to claim 21, further comprising the step, after step (d), wherein the API sub-layer and the interfacing sub-layer communicate directly with each other, free of mediation by the logic sub-layer, when appropriate in view of the health standards and protocols.

38. The method according to claim 21, wherein, in step (d), the interfacing sub-layer disables access of the software application to any location services and/or camera functionalities otherwise afforded by the electronic device.

39. The method according to claim 21, wherein, in steps (d)(ii) and (d)(iii), the logic sub-layer automatically restricts and/or modifies one or more functions of, and communication between, the software application, the operating system and the electronic device.

40. The method according to claim 21, adapted for use with a mobile device or a stationary device as the electronic device.

41. A computer readable medium for use, in health-related fields, by a user of an executable software application and an electronic device having an operating system, the computer readable medium encoded with executable instructions to, when executed, encode one or more processors to automatically perform the steps of:
(a) using an application programming interface (API) sub-layer to communicate with the software application;
(b) using an interfacing sub-layer to communicate with the operating system and/or the electronic device; and
(c) using a logic sub-layer to automatically: (i) receive one or more applicable health standards and protocols from one or more databases, wherein the health standards and protocols govern proper use of health data, operation and quality control of the electronic device, the operating system, and the software application in the health-related fields; (ii) mediate communication between the API sub-layer and the interfacing sub-layer; and (iii) ensure the use of health data, the operation and the quality control of the software application, the operating system and the electronic device are in compliance with all of the applicable health standards and protocols.

42. The computer readable medium according to claim 41, wherein the executable instructions, when executed, further encode the processors to: present a graphical user interface to the user following startup of the electronic device; and use the graphical user interface to mediate interactions of the user with the software application, the operating system and the electronic device.

43. The computer readable medium according to claim 41, wherein the executable instructions, when executed, encode the processors such that, in step (c), the health standards and protocols comprise privacy and security standards and protocols which govern proper privacy and security of health data, the software application, the operating system, and the electronic device in the health-related fields.

44. The computer readable medium according to claim 41, wherein the executable instructions, when executed, encode the processors such that, in step (c), one or more of the health standards and protocols are selected from the group consisting of: the United States' Health Insurance Portability and Accountability Act (HIPAA) standard; the Health Level Seven (HL7) framework and standards; the Hypertext Transfer Protocol Secure (HTTPS) communications protocol; the Point-of-Care Connectivity (POCT1) standard; and the Digital Imaging and Communications in Medicine (DICOM) standard.

45. The computer readable medium according to claim 41, wherein the executable instructions, when executed, encode the processors such that, in step (c), the health standards and protocols comprise in vitro diagnostic protocols which govern proper in vitro diagnostic methodologies for the software application, the operating system, and the electronic device.

46. The computer readable medium according to claim 41, wherein the executable instructions, when executed, encode the processors such that, in step (c), the health standards and protocols are jurisdictionally specific.

47. The computer readable medium according to claim 46, wherein the executable instructions, when executed, encode the processors such that, in step (c), the logic sub-layer automatically receives the health standards and protocols depending on a jurisdiction in which the electronic device is located.

48. The computer readable medium according to claim 41, wherein, in step (c), the databases are located remotely from the electronic device.

49. The computer readable medium according to claim 41, adapted for use with patient results comprising patient identifying information; and wherein the executable instructions, when executed, further encode the processors such that, in step (c), the logic sub-layer restricts access to the patient results other than by the user who collected the patient results.

50. The computer readable medium according to claim 41, wherein the executable instructions, when executed, further encode the processors such that, in step (c), the logic sub-layer anonymizes any patient results which are output from the software application to remove any patient identifying information.

51. The computer readable medium according to claim 41, adapted for use with one or more aggregate results which are anonymously stored in the databases absent any patient identifying information; and wherein the executable instructions, when executed, further encode the processors such that, in step (c), the logic sub-layer permits the software applications to store and/or access the aggregate results.

52. The computer readable medium according to claim 41, adapted for use with the software application stored in the databases; and wherein the executable instructions, when executed, further encode the processors to retrieve the software application from the databases for execution.

53. The computer readable medium according to claim 41, wherein the executable instructions further comprise one or more launcher operating system versions, each adapted to encode the interfacing sub-layer to function with at least one said operating system, agnostic of any intended execution of the software application in association with any said operating system; and wherein the executable instructions, when executed, further encode the processors to perform the further step, before step (b), wherein the interfacing sub-layer automatically receives, depending on the operating system of the electronic device, one of the launcher operating system versions to automatically encode the interfacing sub-layer to function with the operating system of the electronic device.

54. The computer readable medium according to claim 41, wherein the executable instructions further comprise one or more launcher operating system versions, each adapted to encode the API sub-layer to execute the software application in view of an intended execution of the software application with one said operating system, agnostic of the operating system of the electronic device; and wherein the executable instructions, when executed, further encode the processors to perform the further step, before step (a), wherein the API sub-layer automatically receives, depending on the intended execution of the software application with one said operating system, one of the launcher operating system versions to automatically encode the API sub-layer to execute the software application.

55. The computer readable medium according to claim 41, wherein the executable instructions further comprise one or more launcher operating system versions, each adapted to encode the interfacing sub-layer to function with a first one said operating system and to encode the API sub-layer to execute the software application in view of an intended execution of the software application with a second one said operating system different than the first one; and wherein the executable instructions, when executed, further encode the processors to perform the further step, before steps (a) and (b), wherein the interfacing sub-layer and the API sub-layer automatically receive, depending on the first one and the second one said operating system, one of the launcher operating system versions to automatically encode the interfacing sub-layer to function with the operating system of the electronic device, and to automatically encode the API sub-layer to execute the software application.

56. The computer readable medium according to claim 41, wherein the executable instructions, when executed, further encode the processors such that, in step (b) and after step (c), the interfacing sub-layer communicates directly with the electronic device, free of the operating system, when appropriate in view of the health standards and protocols.

57. The computer readable medium according to claim 41, wherein the executable instructions, when executed, further encode the processors to perform the further step, after step (c), wherein the API sub-layer and the interfacing sub-layer communicate directly with each other, free of mediation by the logic sub-layer, when appropriate in view of the health standards and protocols.

58. The computer readable medium according to claim 41, wherein the executable instructions, when executed, encode the processors such that, in step (c), the interfacing sub-layer disables access of the software application to any location services and/or camera functionalities otherwise afforded by the electronic device.

59. The computer readable medium according to claim 41, wherein the executable instructions, when executed, encode the processors such that, in steps (c)(ii) and (c)(iii), the logic sub-layer automatically restricts and/or modifies one or more functions of, and communication between, the software application, the operating system and the electronic device.

60. The computer readable medium according to claim 41, adapted for use with a mobile device or a stationary device as the electronic device.

61. A launcher system for use, in health-related fields, by a user of an executable software application and an electronic device having an operating system; and for use with one or more databases comprising one or more applicable health standards and protocols governing proper use of health data, operation and quality control of the electronic device, the operating system, and the software application in the health-related fields; wherein the launcher system comprises:
(a) an application programming interface (API) sub-layer which communicates with the software application;
(b) an interfacing sub-layer which communicates with the operating system and/or the electronic device; and
(c) a logic sub-layer which automatically (i) receives the health standards and protocols from the databases; (ii) mediates communication between the API sub-layer and the interfacing sub-layer; and (iii) ensures the use of health data, the operation and the quality control of the software application, the operating system and the electronic device are in compliance with all of the applicable health standards and protocols.
